(19) United States
(12) Patent Application Publication
(10) Pub. No.: US 2011/0018754 A1
(43) Pub. Date: Jan. 27, 2011

(54) REMOTE OPERATION APPARATUS, OPERATION TARGET APPARATUS, METHOD FOR CONTROLLING REMOTE OPERATION APPARATUS, METHOD FOR CONTROLLING OPERATION TARGET APPARATUS, AND REMOTE OPERATION SYSTEM

(76) Inventors: Akira Tojima, Osaka (JP); Junichi Shirakawa, Osaka (JP)

Correspondence Address: BIRCH STEWART KOLASCH & BIRCH, PO BOX 747, FALLS CHURCH, VA, 22040-0747, US

(21) Appl. No.: 12/934,571

(22) PCT Filed: Feb. 12, 2009
(86) PCT No.: PCT/JP2009/052291

§ 371 Date: Sep. 24, 2010

(30) Foreign Application Priority Data
Mar. 28, 2008 (JP) 2008-088025
Mar. 28, 2008 (JP) 2008-088026
Jan. 26, 2009 (JP) 2009-014731

(51) Int. Cl. H04L 17/02

(52) U.S. Cl. 341/176

(57) ABSTRACT

A remote operation apparatus (300) includes: an operating-side first communication section (301) that is capable of transmitting a signal to an operation target apparatus (200); an operating-side second communication section (302) that is capable of transmitting/receiving the signal to/from the operation target apparatus (200); a connection start section (11) which transmits a connection start signal, which notifies a start of the transmission/reception of the signal via the operating-side second communication section (302), to the operation target apparatus (200) via the operating-side first communication section (301); and an operating-side communication control section (12) which transmits/receives the signal to/from the operation target apparatus (200) via the operating-side second communication section (302). With this arrangement, it is possible to easily specify a communication partner to/from which a signal is transmitted/received via the operating-side second communication section (302). Moreover, an amount of data transmitted by the operating-side first communication section (301) can be suppressed to a bare minimum. That is, it is possible to easily specify a communication partner and to suppress an amount of data transmitted by communication means for specifying the communication partner to a bare minimum.

### TECHNICAL FIELD

The present invention relates to a remote operation apparatus, an operation target apparatus etc. which allows communication connection to be easily established and allows a pairing process to be easily carried out.

### BACKGROUND ART

Conventionally, a remote controller has been generally used to remotely operate an electronic device. Although many electronic devices available in the market are controlled by dedicated remote controllers for the respective electronic devices, Patent Literature 1 for example proposes a technique for providing a remote controller function to a portable electronic device such as a portable phone and a PDA (Personal Digital Assistance).

Infrared rays are used for signal transmission by a remote controller in many cases including a case of Patent Literature 1 in which a portable electronic device is used as a remote controller. Infrared rays have a disadvantage due to their directivity. Specifically, an electronic device cannot be remotely operated by a remote controller utilizing infrared rays (hereinafter referred to as “infrared remote controller”) in a case where an infrared ray emitting section of the infrared remote controller is not directed towards an infrared ray receiving section of the electronic device or in a case where there is an obstacle between the infrared ray emitting section and the infrared ray receiving section.

Infrared rays have other disadvantages in remote operation. For example, transmittable data amount is limited, and remote operation can be accomplished only at a short distance. Especially, such limitation on transmittable data amount poses a serious problem since, in recent years, there is increasing opportunities of transmitting/receiving, to/from electronics devices, data of relatively large amount such as an image and a video.

In view of the circumstances, techniques for remotely operating an electronic device by using nondirectional communication means such as wireless LAN (Local Area Network) or Bluetooth (registered trademark) instead of infrared rays have been proposed in recent years. These communication means allows greater amount of data to be more speedily transmitted and received, as compared to infrared rays.

By the way, as for an infrared remote controller, because of directivity of infrared rays, an operation target apparatus can be operated by directing the remote controller towards the operation target apparatus. Meanwhile, as for nondirectional communication means, an apparatus that is not intended by a user may be operated since an operation signal is transmitted over a large area around a remote controller.

Accordingly, in a case where communication between a remote controller and an operation target apparatus is established by using nondirectional communication means, the remote controller and the operation target apparatus need to register each other's addresses. This process is called “pairing”. The pairing allows the remote controller and the operation target apparatus to register addresses of respective communication partners, respectively. Use of these addresses can prevent an apparatus that is not intended by a user from being operated since an operation signal transmitted from the remote controller is not received by electronic devices other than the operation target apparatus.

Generally, the pairing process is carried out by exchanging addresses between a remote controller and an operation target apparatus while both of the remote controller and the operation target apparatus are being in a pairing mode.

However, according to the conventional pairing method, a user must carry out complicated operations since not only a remote controller but also an operation target apparatus need to be shifted to a pairing mode.

Specifically, according to the conventional pairing method, before using a remote controller, a user must find out and push a pairing switch provided on an operation target apparatus, and must push a pairing switch provided on the remote controller within a predetermined period of time.

One solution to the complexity of the pairing process is to use the technique disclosed in Patent Literature 2, for example. In the technique disclosed in Patent Literature 2, recognition codes (communication addresses) are exchanged between a remote controller and a television with the use of infrared communication, and then radio wave communication is carried out based on the exchanged recognition codes.

According to the arrangement, pairing between the remote controller and the television can be carried out only by performing a predetermined input operation while the remote controller is being directed towards the television.

As in Patent Literature 2, Patent Literature 3 discloses an apparatus which utilizes two types of communication means (i.e., infrared communication and radio wave communication) for data communication. According to Patent Literature 3, a server apparatus transmits, to a client apparatus, an encryption key for communication connection between the server apparatus and the client apparatus by using infrared communication in a case where the server apparatus receives a radio wave signal supplied from the client apparatus.

According to the arrangement, only a client apparatus disposed within a reach of an infrared-ray signal supplied from the server apparatus can receive the encryption key. As such, communication using a radio wave signal is allowed only between the server apparatus and a specific client apparatus. This increases security of a communication system.

As described above, pairing allows a communication connection to be established between a remote controller and an operation target apparatus through designation of each other's addresses. As a result, it is possible to prevent an apparatus that is not intended by a user from being operated.

However, there arises a problem that in a case where a plurality of remote controllers are paired with a single operation target apparatus, it cannot be determined with which of the plurality of remote controllers a communication connection is established.

Specifically, since the operation target apparatus cannot specify, based on an operation signal supplied from one of a plurality of remote controllers, a transmission source of the operation signal, the operation target apparatus which receives the operation signal cannot judge with which of the plurality of remote controllers a communication connection should be established.

One solution to this problem is to employ an arrangement in which in a case where a plurality of remote controllers are paired with a single operation target apparatus, the operation target apparatus attempts communication connection with the plurality of remote controllers one by one. This allows a communication connection to be established between a remote controller used by a user and the operation target apparatus, thereby allowing the user to operate the operation target apparatus with the use of the remote controller.

However, according to the arrangement, the operation target apparatus attempts communication connection also with remote controllers that are not used by the user. This causes a problem that it takes time to establish a communication connection between the remote controller used by the user and the operation target apparatus. Moreover, there is a risk that a communication connection is mistakenly established between a remote controller that is not used by the user and the operation target apparatus.

As a measure for specifying a remote controller that is being used by a user from a plurality of remote controllers, the technique disclosed in Patent Literature 2 may be adopted for example. According to the technique disclosed in Patent Literature 2, recognition codes (communication addresses) are exchanged between a remote controller and a television with the use of infrared communication, and then radio wave communication is carried out based on the exchanged recognition codes.

According to the arrangement, the address for radio wave communication is transmitted via infrared communication. This allows the television (operation target apparatus) to specify a remote controller which has transmitted the address even if a plurality of remote controllers are paired with an operation target apparatus, thereby making it possible to establish a communication connection with the remote controller thus specified. That is, by specifying a communication partner remote controller via infrared communication, it is possible to establish a communication connection with the remote controller thus specified.

As in Patent Literature 2, Patent Literature 3 discloses an apparatus which utilizes two types of communication means (i.e., infrared communication and radio wave communication) for data communication. According to Patent Literature 3, a server apparatus transmits, to a client apparatus, an encryption key for communication connection between the server apparatus and the client apparatus by using infrared communication in a case where the server apparatus receives a radio wave signal supplied from the client apparatus.

According to the arrangement, only a client apparatus (operation target apparatus) disposed within a reach of an infrared-ray signal supplied from the server apparatus (remote controller) can receive the encryption key. As such, the server apparatus can communicates with only a specific client apparatus with the use of a radio wave signal. That is, by specifying a communication partner client apparatus via infrared communication, it is possible to establish a communication connection with the client apparatus thus specified.

### CITATION LIST

Patent Literature 1

Japanese Patent Application Publication, Tokukai, No. 2002-78042 A (Publication Date: Mar. 15, 2002)

Patent Literature 2

Japanese Patent Application Publication, Tokukaihei, No. 9-215064 A (Publication Date: Aug. 15, 1997)

Patent Literature 3

Japanese Patent Application Publication, Tokukai, No. 2006-339806 A (Publication Date: Dec. 14, 2006)

According to the technique disclosed in Patent Literature 2, recognition codes (addresses for communication) are exchanged by using infrared communication. Further, according to the technique disclosed in Patent Literature 3, an encryption key for radio wave communication is transmitted by using infrared communication.

However, infrared communication which has been widely used for a remote controller or the like does not take into consideration transmission/reception of data such as address information or an encryption key. It is therefore difficult to apply, without modification, infrared communication which has been widely used to the arrangements of Patent Literatures 2 and 3.

That is, a general infrared remote controller is configured to transmit a command signal in accordance with a format defined by Association for Electric Home Appliances. However, this format is designed for transmission of a relatively simple command such as a command for switching on/off an operation target apparatus, and is not designed for transmission of data, such as address and encryption key, which is larger in amount than a general remote controller command.

Meanwhile, IrDA (Infrared Data Association), which is a standard for infrared data transmission, allows data such as address and encryption key to be exchanged via infrared communication. However, since IrDA is hardware that is not provided in a general infrared remote controller, a remote controller in which IrDA is provided is higher in manufacturing cost than a conventional general infrared remote controller. Moreover, there is a problem that a communicatable distance of a remote controller in which IrDA is provided is shorter than that of a general infrared remote controller.

Further, according to the examples of the conventional arts, infrared communication is used as communication means for specifying a communication partner apparatus. However, this communication means is not limited to infrared communication, provided that a communication partner apparatus can be specified. Here, it is preferable that an amount of data transmitted by using such communication means for specifying a communication partner apparatus is smaller.

As described above, according to the conventional pairing methods, a user must carry out complicated operations since not only a remote controller but also an operation target apparatus must be in a pairing mode.

Moreover, in a case where the arrangement of Patent Literature 2 or 3 is applied to a pairing process and communication connection, there arises a problem that conventionally used infrared communication means cannot be used although user's operations for the pairing process and the communication connection can be simplified.

### SUMMARY OF INVENTION

The present invention was attained in view of the above problems, and an object of the present invention is to realize a remote operation apparatus etc. which allows easy pairing even in a case where conventionally used infrared communication means is used and to realize a remote operation apparatus etc. which can easily specify a communication partner so as to establish a communication connection with the communication partner and which allows a data amount of a signal used for communication for specifying the communication partner to be suppressed to a bare minimum.

In order to attain the above object, a remote operation apparatus of the present invention which remotely operates an operation target apparatus paired with the remote operation apparatus by transmitting a signal to the operation target apparatus includes: an operating-side first communication section that is capable of transmitting a signal to the operation target apparatus; an operating-side second communication section that is capable of transmitting/receiving a signal to/from the operation target apparatus; pairing start means which transmits a pairing start signal, which notifies→ instructs a start of a pairing process, to the operation target apparatus via the operating-side first communication section; and operating-side pairing executing means which carries out the pairing process via the operating-side second communication section.

In order to attain the above object, a method of the present invention for controlling a remote operation apparatus which remotely operates an operation target apparatus by transmitting a signal to the operation target apparatus: includes transmitting a pairing start signal, which instructs a start of a pairing process, to the operation target apparatus via an operating-side first communication section that is capable of transmitting a signal to the operation target apparatus; and pairing the remote operation apparatus with the operation target apparatus via an operating-side second communication section that is capable of transmitting/receiving a signal to/from the operation target apparatus.

According to the arrangement, the pairing between the remote operation apparatus and the operation target apparatus is triggered by transmission of the pairing start signal. It is therefore possible for a user to carry out pairing between the remote operation apparatus and the operation target apparatus only by inputting an instruction to transmit the pairing start signal. That is, according to the arrangement, it is possible to very easily carry out a pairing process without causing a burden on the user.

Moreover, the operating-side first communication section is only required to transmit the pairing start signal, and the pairing process in which an address is transmitted and received is carried out via the operating-side second communication section. That is, the operating-side first communication section is not limited particularly, as long as it can transmit a signal for notifying a start of the pairing process. Further, the operating-side first communication section does not need to carry out transmission/reception of an address.

This allows infrared communication means which has been conventionally used for a remote controller etc. to be used as the operating-side first communication section, thereby reducing a manufacturing cost of the remote operation apparatus.

Note that the “pairing” refers to a process in which the remote operation apparatus and the operation target apparatus register each other's addresses in order that a signal is transmitted/received to/from the operation target apparatus via the operating-side second communication section. The pairing allows the remote operation apparatus and the operation target apparatus to communicate with each other through designation of each other's addresses.

In order to attain the above object, an operation target apparatus of the present invention whose operation is controlled based on a signal transmitted from a remote operation apparatus, includes: an operated-side first communication section that is capable of receiving a signal transmitted by the remote operation apparatus; an operated-side second communication section that is capable of transmitting/receiving a signal to/from the remote operation apparatus; and operated-side pairing executing means which pairs the operation target apparatus with the remote operation apparatus via the operated-side second communication section in response to receipt, via the operated-side first communication section, of a pairing start signal for instructing a start of a pairing process.

In order to attain the above object, a method of the present invention for controlling an operation target apparatus whose operation is controlled based on a signal transmitted from a remote operation apparatus includes the steps of: receiving a pairing start signal for instructing a start of a pairing process via an operated-side first communication section that is capable of receiving the signal transmitted by the remote operation apparatus; and pairing the operation target apparatus with the remote operation apparatus via an operated-side second communication section that is capable of transmitting/receiving a signal to/from the remote operation apparatus.

According to the arrangement, the pairing between the remote operation apparatus and the operation target apparatus is triggered by reception of the pairing start signal.

It is therefore possible for a user of the remote operation apparatus to carry out pairing between the remote operation apparatus and the operation target apparatus only by inputting an instruction to transmit the pairing start signal. That is, according to the arrangement, it is possible to very easily carry out a pairing process without causing a burden on the user.

Moreover, the operated-side first communication section is only required to receive the pairing start signal, and the pairing process in which an address is transmitted and received is carried out via the operated-side second communication section.

This allows infrared communication means which has been conventionally used for a remote controller etc. to be used as the operated-side first communication section, thereby reducing a manufacturing cost of the operation target apparatus.

In order to attain the above object, another remote operation apparatus of the present invention which remotely operates an operation target apparatus by transmitting a signal to the operation target apparatus, includes: an operating-side first communication section that is capable of transmitting a signal to the operation target apparatus; an operating-side second communication section that is capable of transmitting/receiving a signal to/from the operation target apparatus; communication start control means which transmits a connection start signal, which notifies a start of the transmission/reception of the signal via the operating-side second communication section, to the operation target apparatus via the operating-side first communication section; and operating-side communication control means which transmits/receives the signal to/from the operation target apparatus via the operating-side second communication section.

In order to attain the above object, a method of the present invention for controlling a remote operation apparatus which remotely operates an operation target apparatus by transmitting a signal to the operation target apparatus, the remote operation apparatus including an operating-side first communication section that is capable of transmitting a signal to the operation target apparatus; and an operating-side second communication section that is capable of transmitting/receiving a signal to/from the operation target apparatus, includes the steps of: transmitting a connection start signal, which notifies a start of the transmission/reception of the signal via the operating-side second communication section, to the operation target apparatus via the operating-side first communication section; and transmitting/receiving the signal to/from the operation target apparatus via the operating-side second communication section.

According to the arrangement, transmission of the connection start signal acts as a trigger which causes the remote operation apparatus to start transmission/reception of a signal to/from the operation target apparatus via the operating-side second communication section. It is therefore possible to specify, as an apparatus to/from which a signal is transmitted/received via the operating-side second communication section, the operation target apparatus to which the connection start signal has been transmitted. That is, according to the arrangement, it is possible to very easily specify an apparatus to/from which a signal is transmitted/received via the operating-side second communication section.

Moreover, the operating-side first communication section is only required to transmit the connection start signal in order to specify an apparatus to/from which a signal is transmitted/received via the operating-side second communication section. This allows an amount of data transmitted by the operating-side first communication section to be suppressed to a bare minimum. As a result, according to the arrangement, it is possible to use, as the operating-side first communication section, infrared communication means which has been conventionally used for a remote controller etc., thereby reducing a manufacturing cost of the remote operation apparatus.

In order to attain the above object, an operation target apparatus of the present invention whose operation is controlled based on a signal transmitted from a remote operation apparatus, includes: an operated-side first communication section that is capable of receiving a signal transmitted by the remote operation apparatus; an operated-side second communication section that is capable of transmitting/receiving a signal to/from the remote operation apparatus; and the operated-side communication control means which transmits/receives the signal to/from the remote operation apparatus via the operated-side second communication section in response to receipt, via the operated-side first communication section, of a connection start signal for notifying a start of the transmission/reception of the signal via the operated-side second communication section.

In order to attain the above object, a method of the present invention for controlling an operation target apparatus whose operation is controlled based on a signal transmitted from a remote operation apparatus, the operation target apparatus including: an operated-side first communication section that is capable of receiving a signal transmitted by the remote operation apparatus; and an operated-side second communication section that is capable of transmitting/receiving a signal to/from the remote operation apparatus, includes the steps of: receiving, via the operated-side first communication section, a connection start signal for notifying a start of the transmission/reception of the signal via the operated-side second communication section; and transmitting/receiving the signal to/from the remote operation apparatus via the operated-side second communication section in response to receipt of the connection start signal.

According to the arrangement, transmission of the connection start signal acts as a trigger which causes the remote operation apparatus to start transmission/reception of a signal to/from the operation target apparatus via the operating-side second communication section. It is therefore possible to specify, as an apparatus to/from which a signal is transmitted/received via the operated-side second communication section, the remote operation apparatus which has transmitted the connection start signal. That is, according to the arrangement, it is possible to very easily specify an apparatus to/from which a signal is transmitted/received via the operated-side second communication section.

Moreover, the operated-side first communication section is only required to receive the connection start signal in order to specify an apparatus to/from which a signal is transmitted/received via the operated-side second communication section. This allows an amount of data received by the operated-side first communication section to be suppressed to a bare minimum. As a result, according to the arrangement, it is possible to use, as the operated-side first communication section, infrared communication means which has been conventionally used for a remote controller etc., thereby reducing a manufacturing cost of the operation target apparatus.

Note that the remote operation apparatus and the operation target apparatus may be realized by a computer. In this case, the present invention includes a control program for causing a computer to function as each means of the remote operation apparatus and the operation target apparatus so that the remote operation apparatus and the operation target apparatus are realized by the computer, and a computer-readable recording medium in which the control program is stored.

Additional objects, features, and strengths of the present invention will be made clear by the description below. Further, the advantages of the present invention will be evident from the following explanation in reference to the drawings.

### BRIEF DESCRIPTION OF DRAWINGS

FIG. 1 shows an embodiment of the present invention, and is a block diagram illustrating a main configuration of an operation target apparatus and a remote operation apparatus.

FIG. 2 is a block diagram illustrating a main configuration of a remote operation system including the operation target apparatus and the remote operation apparatus.

FIG. 3 (a) is a view schematically illustrating the remote operation system (pairing process).

FIG. 3 (b) is a view schematically illustrating the remote operation system (reconnection process).

FIG. 4 is a view illustrating an example of a screen displayed when a remote controller application is activated in the remote operation apparatus.

FIG. 5 is a view illustrating an example of a screen displayed on the remote operation apparatus when the “television” is selected as an apparatus to be operated by the remote oration apparatus.

FIG. 6 is a view illustrating an example of a case where a conventional general remote controller is used as the remote operation apparatus.

FIG. 7 is a flowchart illustrating an example of processes in the remote operation system.

FIG. 8 is a flowchart illustrating an example of the reconnection process in the remote operation system.

FIG. 9 is a flowchart illustrating an example of the pairing process in the remote operation system.

FIG. 10 is a flowchart illustrating an example of a data transmitting/receiving process in the remote operation system.

FIG. 11 shows another embodiment of the present invention, and is a flowchart illustrating an example of a process carried out in the remote operation system in which a pairing process is carried out every time.

FIG. 12 is a flowchart illustrating an example of processes carried out by the operation target apparatus and the remote operation apparatus in still another embodiment of the present invention.

FIG. 13 is a view illustrating an example of a screen displayed on a display section of the remote operation apparatus when the processes are carried out.

FIG. 14 is a view illustrating an example of a screen displayed on a display section of the operation target apparatus when the processes are carried out.

### REFERENCE SIGNS LIST

1: Operated-side pairing executing section (operated-side pairing executing means)
2: Operated-side connection destination management section (operated-side connection destination collating means)
3: Operated-side communication control section (operated-side communication control means)
4: Connection destination management table (operated-side connection destination storage section)
11: Connection start section (communication start control means)
12: Operating-side communication control section (operated-side communication control means)
13: Operating-side connection destination management section (operating-side connection destination collating means)
14: Operating-side pairing executing section (operating-side pairing executing means)
15: Connection destination storage section (Operating-side connection destination storage section)
16: Identification information storage section
17: Pairing start section (pairing start means)
100: Remote operation system
200: Operation target apparatus
203: Operation target apparatus control section
208: Operated-side first communication section
209: Operated-side second communication section
300: Remote operation apparatus
301: Operating-side first communication section
302: Operating-side second communication section
306: Remote operation apparatus control section

### DESCRIPTION OF EMBODIMENTS

### Embodiment 1

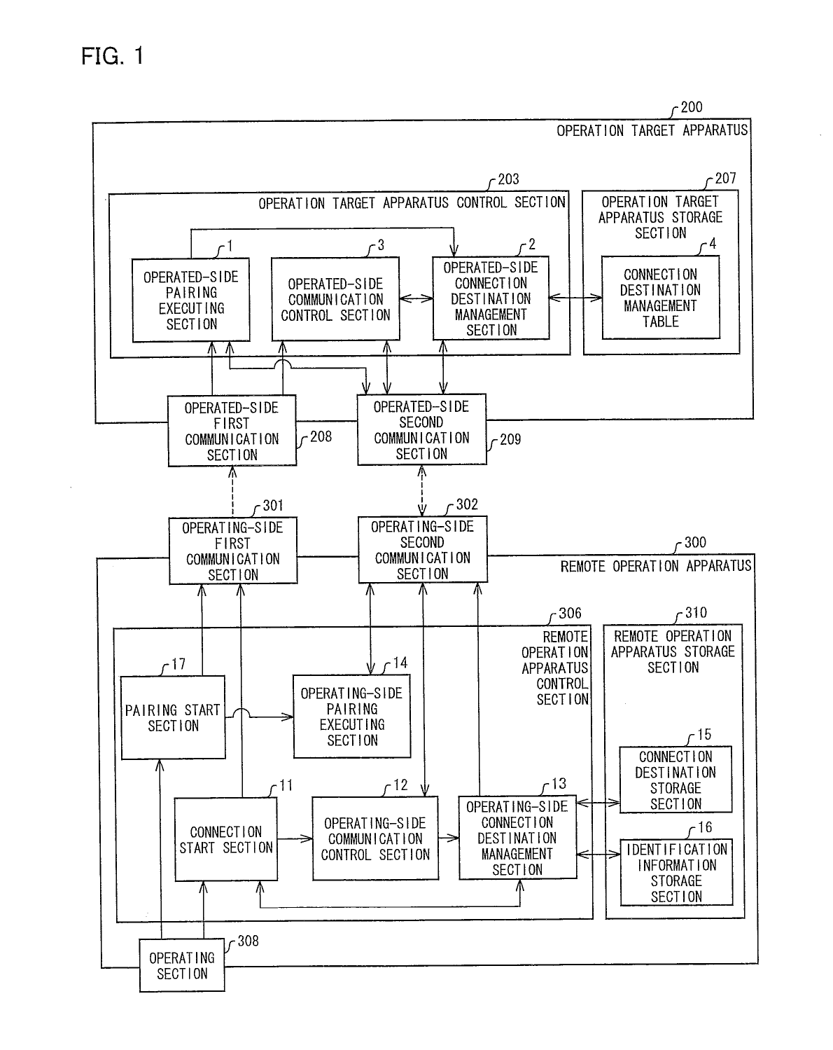

The following describes an embodiment of the present invention with reference to FIGS. 1 through 10.

### [Overview of System]

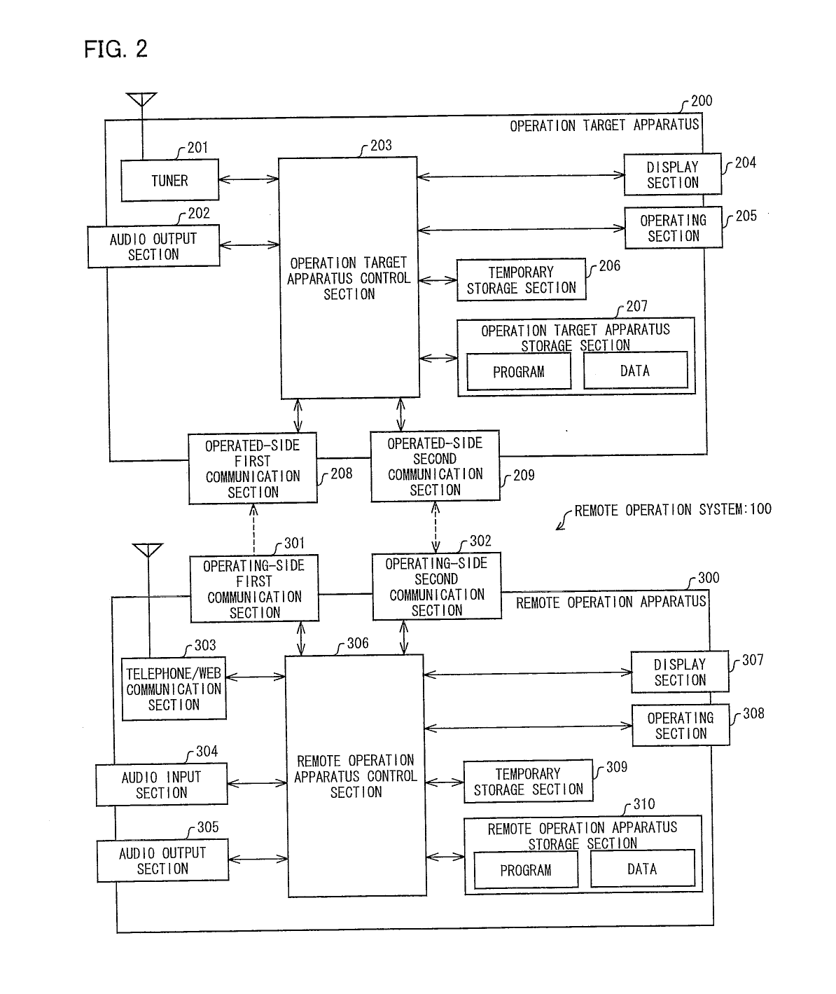

FIG. 2 is a block diagram illustrating a main configuration of a remote operation system 100. As shown in FIG. 2, the remote operation system 100 includes an operation target apparatus 200 and a remote operation apparatus 300. The remote operation system 100 is a system in which the operation target apparatus 200 is operated with the use of the remote operation apparatus 300. In the present embodiment, it is assumed that the remote operation apparatus 300 is a mobile phone, and the operation target apparatus 200 is a television receiver.

Note that the remote operation system 100 is not limited to this example as long as the remote operation system 100 is a system in which the remote operation apparatus 300 can operate the operation target apparatus 200. For example, the remote operation apparatus 300 can be a PDA (Personal Digital Assistance), a PHS (Personal Handy Phone System), a laptop computer, a portable game device, or the like, as long as each of these has a function to operate the operation target apparatus 200 by transmitting an operation signal. Of course, the remote operation apparatus 300 can be a dedicated remote controller for operating the operation target apparatus 200. The operation target apparatus 200 can be, for example, a personal computer, a picture recorder, a music player, an air conditioner, or the like, as long as these devices receive an operation signal transmitted from the remote operation apparatus 300 and operations of each of these devices can be controlled based on the operation signal.

### [Configuration of Operation Target Apparatus 200]

As shown in FIG. 2, the operation target apparatus 200 includes a tuner 201, an audio output section 202, an operation target apparatus control section 203, a display section 204, an operating section 205, a temporary storage section 206, an operation target apparatus storage section 207, an operated-side first communication section 208, and an operated-side second communication section 209.

The tuner 201 (i) selects and receives a broadcast wave of a channel designated by the operation target apparatus control section 203, (ii) converts the broadcast wave into a predetermined signal, and (iii) outputs the predetermined signal. The operation target apparatus 200 carries out a process such as decoding on the predetermined signal, and thereby outputs video and audio of the received channel. Note that it is sufficient as long as the tuner 201 has functions to receive a broadcast wave and to convert the received broadcast wave into a predetermined signal. For example, according to need, a conventional general tuner, such as a terrestrial digital tuner, a BS tuner, a CS tuner, or the like, can be used as the tuner 201.

The audio output section 202 outputs audio outside of the operation target apparatus 200, in response to an output from the tuner 201 and an instruction from the operation target apparatus control section 203. The audio output section 202 can be made up of, for example, a speaker.

The operation target apparatus control section 203 totally controls operations of the operation target apparatus 200. The operation target apparatus control section 203 can be made up of, for example, a CPU (Central Processing Unit), etc. The operation target apparatus control section 203 operates with the use of a temporary storage section 107 made up of, for example, a RAM (Random Access Memory), etc., as a work area. Note that details of processes carried out by the operation target apparatus control section 203 are specifically described later.

The display section 204 is a display device which displays video in response to an output from the tuner 201 and an instruction from the operation target apparatus control section 203. The display section 204 can be, for example, an LC (Liquid Crystal) display panel, an EL (Electro Luminescence) display panel, a CRT (cathode-ray tube) display device, or the like.

The operating section 205 is used by a user for carrying out an input for operating the operation target apparatus 200. The operating section 205 is not limited in particular, as long as the user can carry out an intended operating input. In the present embodiment, it is assumed that operating keys corresponding to various operating inputs are provided as the operating section 205. Specifically, it is assumed that operating keys are provided for respective operating inputs for changing channels, sound volume adjustment, power on/off of the operation target apparatus 200, and the like.

As shown in FIG. 2, the operation target apparatus storage section 207 stores a program and data. The operation target apparatus control section 203 (i) reads out the program stored in the operation target apparatus storage section 207 to the temporary storage section 206 and (ii) executes the program thus read out. This allows the operation target apparatus 200 to execute a predetermined operation.

The operated-side first communication section 208 and the operated-side second communication section 209 enable the operation target apparatus 200 to communicate with external devices. The operated-side first communication section 208 is configured so that the operated-side first communication section 208 can communicate with an operating-side first communication section 301. The operated-side second communication section 209 is configured so that the operated-side second communication section 209 can communicate with an operating-side second communication section 302. Details of the operated-side first communication section 208 and the operated-side second communication section 209 are described later.

### [Configuration of Remote Operation Apparatus 300]

As shown in FIG. 2, the remote operation apparatus 300 includes the operating-side first communication section 301, the operating-side second communication section 302, a telephone/web communication section 303, an audio input section 304, an audio output section 305, a remote operation apparatus control section 306, a display section 307, an operating section 308, a temporary storage section 309, and a remote operation apparatus storage section 310.

The operating-side first communication section 301 and the operating-side second communication section 302 enable the remote operation apparatus 300 to communicate with external devices. The operating-side first communication section 301 is configured so that the operating-side first communication section 301 can communicate with the operated-side first communication section 208. The operating-side second communication section 302 is configured so that the operating-side second communication section 302 can communicate with the operated-side second communication section 209. Details of the operating-side first communication section 301 and the operating-side second communication section 302 are described later.

The telephone/web communication section 303 is used in telephone calls to another mobile phone or an ordinary telephone via mobile phone network, etc., or used in communication via the Internet. These functions are realized by a telephone network communication section (not illustrated) and a mobile phone line section (not illustrated). The telephone/web communication section 303 can be a member used in a conventional mobile phone, etc., as long as the member has at least a function of telephone call.

The audio input section 304 is used for inputting an audio signal to the remote operation apparatus 300 in a telephone call, etc, for example. The audio output section 305 outputs audio in response to an audio signal, etc. received by the telephone/web communication section 303 in a telephone call, etc. Moreover, the audio output section 305 outputs sound, etc. for announcing incoming of a call, e-mail, or the like. The audio input section 304 and the audio output section 305 can be members which are used in a conventional mobile phone, etc., as long as the respective members can input and output audio.

The remote operation apparatus control section 306 totally controls operations of the remote operation apparatus 300. The remote operation apparatus control section 306 can be made up of, for example, a CPU, etc. The remote operation apparatus control section 306 operates with the use of, as a work area, a temporary storage section 129 which is made up of, for example, a RAM, etc. Note that details of processes carried out by the remote operation apparatus control section 306 are specifically described later.

The display section 307 displays an image in response to an instruction from the remote operation apparatus control section 306. Although not illustrated, components such as a VDP (Video Display Processor) and a VRAM (video Ram), etc., which are necessary to display an image, are provided as appropriate between the remote operation apparatus control section 306 and the display section 307. The display section 307 can be made up of, for example, a LC display panel, an EL display panel, or the like.

The operating section 308 is used by a user of the remote operation apparatus 300 for carrying out an operating input on the remote operation apparatus 300. The operating section 308 is not limited in particular, as long as the user can carry out an intended operating input. In the present embodiment, it is assumed that the operating section 308 is operating keys provided on a surface of the remote operation apparatus 300. Specifically, it is assumed that the operating keys can be a plurality of operating keys including (i) various menu keys for causing the display section 307 to display menu screens relating to e-mail, Internet connection, and the like, (ii) direction keys of up, down, right, and left for selecting items displayed on the display section 307, (iii) a decision key for deciding a selected item, and (iv) character input keys for inputting numerals and characters.

As shown in FIG. 2, the remote operation apparatus storage section 310 stores a program and data. The remote operation apparatus control section 306 (i) reads out the program stored in the remote operation apparatus storage section 310 to the temporary storage section 309 and (ii) executes the program thus read out. This allows the remote operation apparatus 300 to execute a predetermined operation. Moreover, the remote operation apparatus storage section 310 is to store, for example, data of e-mail, etc. received by the telephone/web communication section 303, and data of telephone numbers and e-mail addresses, etc. registered by the user of the remote operation apparatus 300.

[Communication Means Used in Remote Operation System 100]

As described above, in the remote operation system 100, the operating-side first communication section 301 is provided so that the operating-side first communication section 301 can communicate with the operated-side first communication section 208. Moreover, the operating-side second communication section 302 is provided so that the operating-side second communication section 302 can communicate with the operated-side second communication section 209. That is, according to the remote operation system 100, the remote operation apparatus 300 and the operation target apparatus 200 can communicate with each other via (i) a first communication path formed by the operating-side first communication section 301 and the operated-side first communication section 208 and (ii) a second communication path formed by the operating-side second communication section 302 and the operated-side second communication section 209 (see FIG. 2).

The first communication path formed by the operating-side first communication section 301 and the operated-side first communication section 208 is used when the remote operation apparatus 300 specifies the operation target apparatus 200 as a target to be remotely controlled. More specifically, the remote operation apparatus 300 specifies, as a target to be remotely controlled, the operation target apparatus 200 with which the remote operation apparatus 300 can communicate via the first communication path.

For example, in a case where two television devices are to be operated by the remote operation apparatus 300, one of the two television devices which one can communicate with the remote operation apparatus 300 via the first communication path becomes a target to be remotely operated. Note that, in a case of devices of different categories such as a television device and a picture recorder, interference does not occur in general because commands for infrared remote control are defined separately.

In order to specify a target to be remotely operated, for example, communication means which have high directivity can be applied to the first communication path. That is, it is preferable that communication means having a relatively narrow communication range is applied to the first communication path so that communication can be established only with one of electronic devices disposed close to the remote operation apparatus 300.

In the present embodiment, it is assumed that infrared communication is applied to the first communication path. That is, according to the remote operation system 100, in a case where an infrared signal emitted from the operating-side first communication section 301 is received by the operated-side first communication section 208, the operation target apparatus 200 is to be specified as an apparatus which communicates with the remote operation apparatus 300.

Note that, in the present embodiment, it is assumed that the first communication path is used in order the remote operation apparatus 300 to specify the operation target apparatus 200 which the remote operation apparatus 300 is to communicate with. Accordingly, it is assumed that the operating-side first communication section 301 is an infrared-emitting section and the operated-side first communication section 208 is an infrared-receiving section. Note that the operating-side first communication section 301 can have an infrared-receiving section in addition to the infrared-emitting section and the operated-side first communication section 208 can have an infrared-emitting section in addition to the infrared-receiving section.

It is sufficient as long as a target to be remotely operated can be specified with the first communication path. Accordingly, it is not necessary that a large amount of data can be transmitted and received via the first communication path. Therefore, an infrared-emitting device and an infrared-receiving device for use in a conventional general infrared remote controller can be used as the operating-side first communication section 301 and operated-side first communication section 208, respectively. As such, a configuration of an infrared remote controller which is widely used at present can be applied to the remote operation apparatus 300 and the operation target apparatus 200. This makes it possible to hold down manufacturing costs of the remote operation apparatus 300 and the operation target apparatus 200.

Note that the configurations of the operating-side first communication section 301 and the operated-side first communication section 208 are not limited to the examples, as long as a target to be remotely controlled can be specified via the first communication path. For example, FeliCa (registered trademark), etc. can be applied to the first communication path.

On the other hand, the second communication path formed by the operating-side second communication section 302 and the operated-side second communication section 209 is used in transmitting and receiving data between the remote operation apparatus 300 and the operation target apparatus 200. Moreover, according to the second communication path, a communication target can be identified by an address.

The second communication path is used in transmitting and receiving data. Accordingly, it is preferable that a large amount of data can be transmitted and received at high speed via the second communication path, as compared to the first communication path. Moreover, it is also preferable that the second communication path has low directivity (communication range is wide) so that communication can be maintained even in a case where relative positional relation between the operation target apparatus 200 and the remote operation apparatus 300 is changed.

In the present embodiment, it is assumed that Bluetooth (registered trademark) communication is applied to the second communication path. That is, the operated-side second communication section 209 and the operating-side second communication section 302 are communication sections which can carry out transmission and reception of a signal via Bluetooth communication. Note that a wireless LAN such as IEEE802.11 radio transmission or ZigBee (registered trademark), etc. can be applied to the second communication path, as long as communication can be carried out by identifying an address of a communication target.

### MAIN POINTS OF INVENTION

As described above, according to the remote operation system 100, (i) infrared communication can be carried out between the operating-side first communication section 301 and the operated-side first communication section 208, and (ii) Bluetooth communication can be carried out between the operating-side second communication section 302 and the operated-side second communication section 209.

According to the present embodiment, the infrared communication, which is directional communication, can be carried out when the operating-side first communication section 301 faces the operated-side first communication section 208 so that an infrared signal transmitted from the operating-side first communication section 301 can be received by the operated-side first communication section 208.

On the other hand, the Bluetooth communication is nondirectional communication. Accordingly, in a case where the Bluetooth communication is carried out between the operating-side second communication section 302 and the operated-side second communication section 209, it is necessary to carry out, in advance, a pairing process for registering a communication target device for the Bluetooth communication so that other device which the user does not intend to operate would not be mistakenly operated.

In the pairing process, the operation target apparatus 200 and the remote operation apparatus 300 register each other's addresses for the Bluetooth communication. The Bluetooth communication is carried out through designation of each other's addresses, and this makes it possible to prevent unintended operation of a device which the user does not intend to operate.

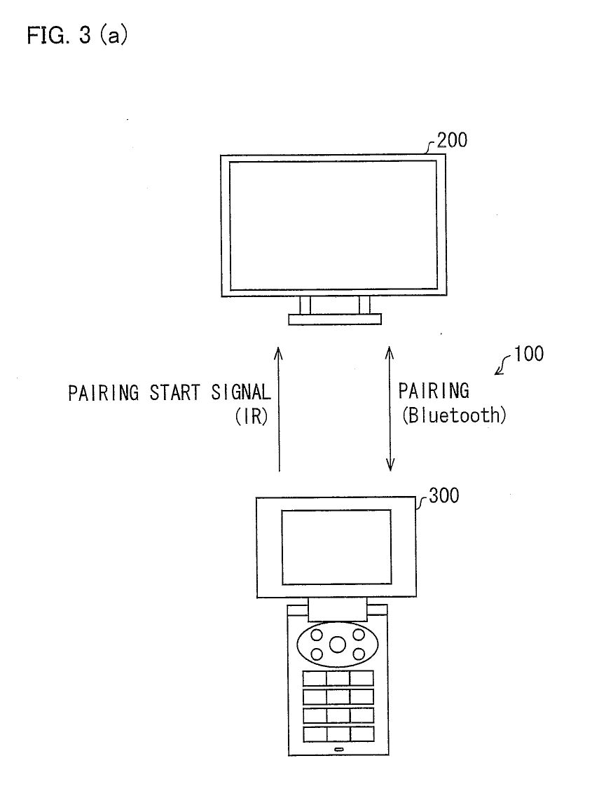

The present invention has a main characterizing feature in a method for carrying out the pairing process. The following describes the method for carrying out the pairing process with reference to FIG. 3 (a). FIG. 3 (a) is a view schematically illustrating the remote operation system 100 of the present invention. As shown in FIG. 3 (a), the remote operation apparatus 300 transmits a pairing start signal for starting the pairing process to the operation target apparatus 200 via infrared communication.

When the remote operation apparatus 300 transmits the pairing start signal, the remote operation apparatus 300 shifts to a pairing mode in which the pairing process can be carried out. Further, the operation target apparatus 200 which has received the pairing start signal also shifts to the pairing mode. In this manner, both the remote operation apparatus 300 and the operation target apparatus 200 shift to the pairing mode, and during this state, pairing is carried out via the Bluetooth communication.

According to the configuration, the pairing start signal is transmitted via infrared communication. Accordingly, only the operation target apparatus 200 which the operating-side first communication section 301 of the remote operation apparatus 300 faces shifts to the pairing mode. That is, according to the configuration, the user can specify an apparatus to be paired with, by causing the operating-side first communication section 301 to face the apparatus.

According to the configuration, the remote operation apparatus 300 which has transmitted a pairing start signal and the operation target apparatus 200 which has received the pairing start signal shift to the pairing mode. Therefore, in a case where the pairing process is carried out via Bluetooth communication, an electronic device which the user does not intend to operate cannot be paired with even in a case where other electronic devices are present within a communication range of the Bluetooth communication.

The pairing start signal is not limited in particular, as long as the pairing start signal serves as a trigger which causes the operation target apparatus 200 to start the pairing process. The pairing start signal does not need to contain address information used in Bluetooth communication. This makes it possible to suppress an information amount of the pairing start signal to a drastically small amount, and accordingly widely used conventional infrared communication means can be used without modification.

On the other hand, according to the technique of Japanese Patent Application Publication, Tokukaihei, No. 9-215064 cited in the above [Background Art], address information is exchanged via infrared communication. In the technique, however, it is difficult to use widely used conventional infrared communication means without modification because transmission and reception of data which contains relatively large amount of information, such as address information, is not assumed by a widely used conventional signal format for an infrared remote controller which format is specified by Association for Electric Home Appliances.

Moreover, according to the configuration, the pairing process is carried out via the nondirectional Bluetooth communication. Therefore, after the pairing start signal is transmitted, the pairing process can be carried out certainly, even in a case where the remote operation apparatus 300 is moved. On the other hand, according to the technique of Tokukaihei, No. 9-215064, it may occur that the pairing process would not be carried out properly in a case where the remote controller is moved outside of a range of infrared communication while address information is being exchanged, or a case where the infrared signal is blocked off when, for example, a person passes between the remote controller and the television device.

The present invention has another characterizing feature in a reconnection method after the pairing process. The following describes the reconnection method with reference to FIG. 3 (b). FIG. 3 (b) is a view schematically illustrating the remote operation system 100 of the present invention. As shown in FIG. 3 (b), the remote operation apparatus 300 transmits a connection start signal via infrared (IR) communication which signal causes the operation target apparatus 200 to start a reconnection process. Note that, in FIG. 3 (b), it is assumed that the operation target apparatus 200 and the remote operation apparatus 300 have already been paired with each other.

When the remote operation apparatus 300 transmits the connection start signal, the remote operation apparatus 300 shifts to a connection awaiting state in which the reconnection process can be carried out. The operation target apparatus 200 which has received the connection start signal transmits the connection start signal to the remote operation apparatus 300 and starts the reconnection process.

According to the configuration, the connection start signal is transmitted via infrared communication, and whereby the operation target apparatus 200, which the operating-side first communication section 301 of the remote operation apparatus 300 faces, starts the reconnection process. That is, according to the configuration, the user can easily specify an apparatus to be connected, by causing the operating-side first communication section 301 to face the apparatus.

The connection start signal is not limited in particular, as long as the connection start signal serves as a trigger for causing the operation target apparatus 200 to start the reconnection process. The connection start signal does not need to contain address information, etc. used in Bluetooth communication. This makes it possible to suppress an information amount of the connection start signal to a drastically small amount. Accordingly, the connection start signal can be generated in accordance with a signal format for an infrared remote controller specified by Association for Electric Home Appliances. Therefore, a widely used conventional infrared communication means can be used without modification.

Moreover, according to the configuration, the reconnection process is carried out via the nondirectional Bluetooth communication. Therefore, after the connection start signal is transmitted, the reconnection process can be carried out certainly, even in a case where the remote operation apparatus 300 is moved.

[Remote Controller Application]

The remote operation apparatus 300 normally operates as a mobile phone. However, by activating a predetermined application program (hereinafter, referred to as remote controller application), the remote operation apparatus 300 comes to be able to operate the operation target apparatus 200. As such, the operation target apparatus 200 can be remotely operated by various electronic devices by installing the remote controller application into the various electronic devices.

In particular, mobile phones which have infrared communication means and/or Bluetooth communication means as transmission and reception means for data are widely used. Therefore, it is preferable to use a mobile phone as the remote operation apparatus 300 because the communication means for data communication can be used also as communication means for remote operation.

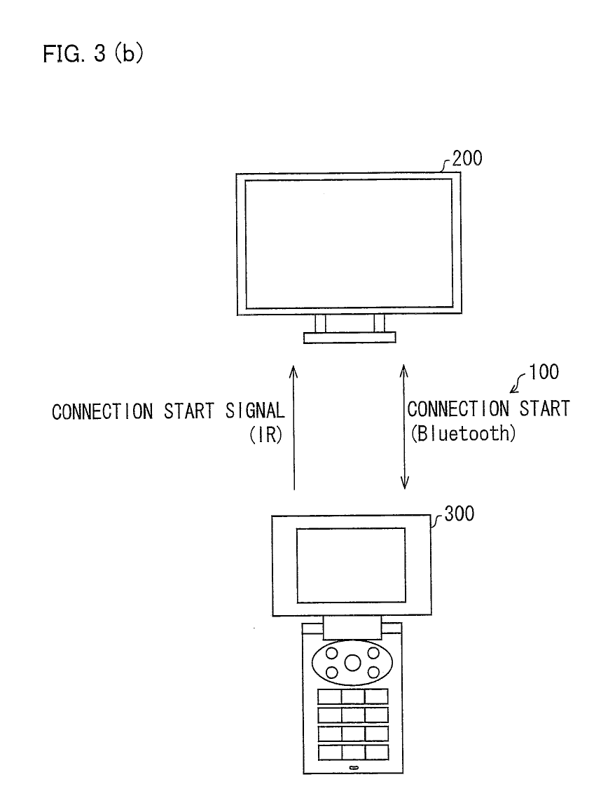

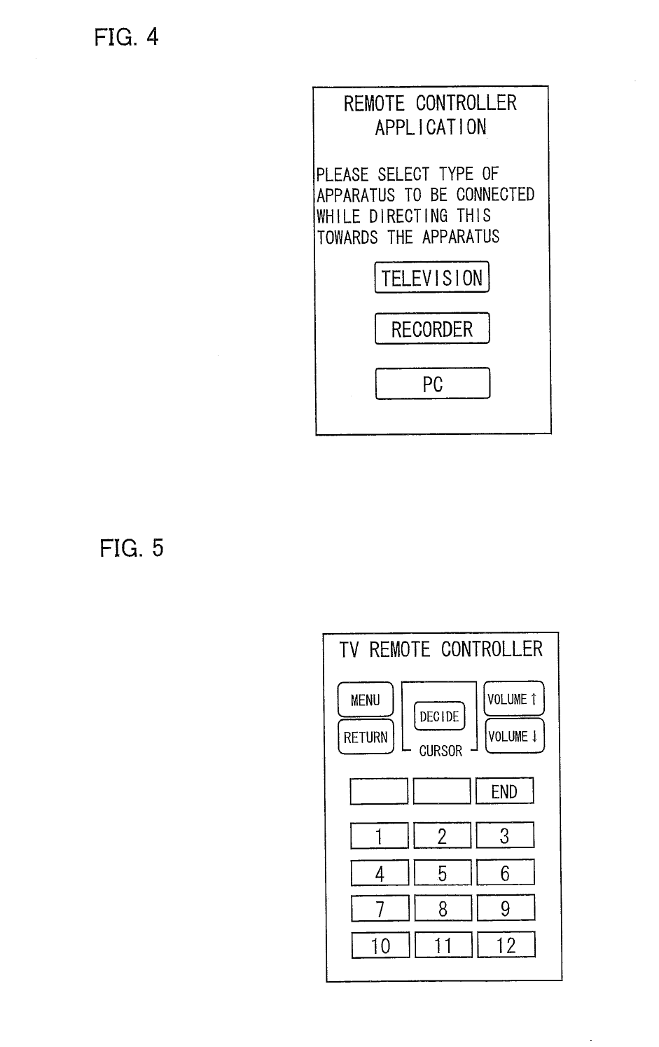

The following describes an example of a display screen displayed when the remote controller application is activated, with reference to FIGS. 4 and 5. FIG. 4 is a view illustrating an example of a screen displayed on the display section 307 when the remote controller application is activated.

In the example of FIG. 4, an image is displayed which encourages the user to select a type of an apparatus to be connected from among a “television”, a “recorder”, or a “PC”. That is, the example shown in FIG. 4 illustrates a case where the three types of apparatuses “television”, “recorder”, or “PC” can be operated by the remote operation apparatus 300. Note that the “recorder” indicates a picture recorder for recording television programs, etc., and the “PC” indicates a personal computer.

As described in FIG. 3, according to the remote operation system 100, when a pairing start signal is transmitted via infrared communication, a pairing process is started. The infrared communication is directional communication, and therefore it is necessary to transmit the pairing start signal while the remote operation apparatus 300 is being caused to face an operation target apparatus (the operation target apparatus 200 in the case of the remote operation system 100). Therefore, in the example shown in FIG. 4, a massage is displayed which encourages the user to carry out the operation for selecting an operation target apparatus while pointing the remote operation apparatus 300 toward the operation target apparatus.

In a case where pairing of the remote operation apparatus 300 and the operation target apparatus 200 has not been carried out yet, the pairing is carried out as shown in FIG. 3 when an operation for selecting the “television” in FIG. 4 is carried out while the remote operation apparatus 300 (more specifically, the operating-side first communication section 301) is being caused to face the operation target apparatus 200 (more specifically, the operated-side first communication section 208).

The pairing allows the remote operation apparatus 300 to certainly operate only the “television” even in a case where other electronic devices are present within a communication range of Bluetooth communication. Note that, in a case where pairing has already been carried out between the remote operation apparatus 300 and the “television”, pairing is not carried out when an operation for selecting the “television” in FIG. 4 is carried out.

When the pairing is completed, an image as shown in FIG. 5 is displayed on the display section 307. FIG. 5 is a view illustrating an example of an image displayed on the display section 307 when the “television” is selected on the screen as shown in FIG. 4. The image shown in FIG. 5 is called as a software keyboard display (hereinafter, referred to as soft-key display). In the soft-key display, operation keys included in the operating section 308 are arranged and the functions assigned to the respective operation keys are displayed.

In the operating section 308, the operation keys are aligned in the same arrangement as that shown in FIG. 5. When an operating key of the operating section 308 corresponding to a key displayed in the display section 307 is input-operated, a process corresponding to a function displayed on the key is carried out. For example, when an operating key of the operating section 308 corresponding to a key displaying “volume ↑” in FIG. 5 is input-operated, sound volume of the television is increased.

The soft-key display makes it possible to assign arbitrary remote controlling operations to the operating keys of the operating section 308. This enables the remote operation apparatus 300 having a function of a mobile phone to operate the operation target apparatus 200.

Note that the remote operation apparatus 300 is not limited to the example as long as an input for remote operation can be carried out with the remote operation apparatus 300. For example, it is possible that (i) the display section 307 and the operating section 308 of the remote operation apparatus 300 are made up of a touch panel, (ii) the display section 307 is caused to display an image for remote controlling, and (iii) the display section 307 is caused to accept remote controlling inputs corresponding to the displayed image.

[Example of Case where General Remote Controller is Used]

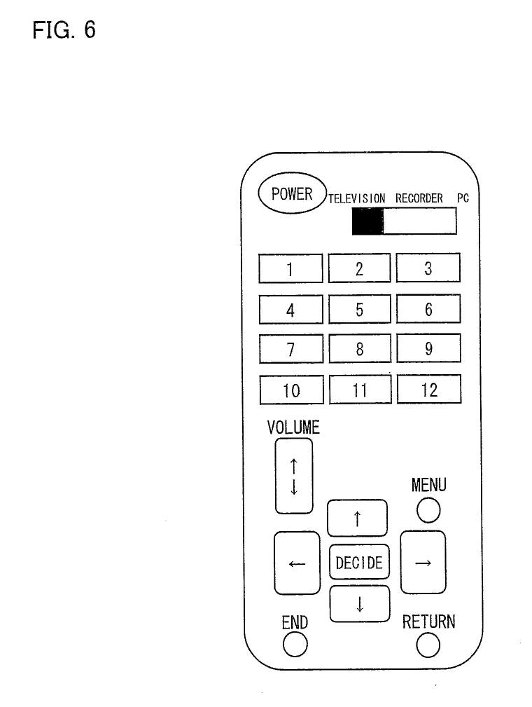

In the present embodiment, the remote operation apparatus 300 having a function of a mobile phone is discussed. However, it is possible to use a conventional general remote controller as the remote operation apparatus of the present invention. FIG. 6 is a view illustrating an example of a case where a conventional general remote controller is used as the remote operation apparatus of the present invention.

The remote operation apparatus shown in FIG. 6 displays (i) a “power button” for switching ON/OFF of power supply, (ii) “numeral buttons” respectively represent numerals 1 through 12 for switching channels, etc., (iii) a “sound volume button” for increasing or decreasing sound volume, (iv) a “menu button” for causing a menu image to be displayed, (v) “direction buttons” respectively represent up, down, right, and left, (vi) a “decision button” used for deciding a process, etc., (vii) an “end button” used for ending a process, and (viii) a “return button” for causing a screen display to return to one image before.

Further, on the remote operation apparatus shown in FIG. 6, a selector switch is provided which selector switch is for switching a target to be operated by the remote operation apparatus among a television, a recorder, and a PC. In the example shown in FIG. 6, the selector switch is set for the television. Accordingly, when the buttons are operated in the state, operations of the television (such as switching of ON/OFF of power supply, or switching of channels) can be controlled.

In a case where the remote operation apparatus of the present invention is a general remote controller as shown in FIG. 6, a pairing process can be started when the selector switch is shifted. In a case where the pairing has already been done, a reconnection process can be started when the selector switch is shifted. For example, when the selector switch is shifted to the “recorder” from the state shown in FIG. 6, pairing or reconnection with the recorder can be carried out.

Note that, in a case where the selector switch is shifted to the “PC” from the state shown in FIG. 6, the selector switch is to pass through the “recorder” on the way to the “PC”. This may cause pairing or reconnection with the “recorder”, even though the user wants to operate the “PC”. Such a situation can be avoided by, for example, setting the pairing or the reconnection to be started when a predetermined time period or more elapses after the selector switch is set to a single operation target apparatus.

When connection with the television is carried out in a case where the selector switch is already set to the “television” as shown in FIG. 6, pairing or reconnection with the television can be carried out when, for example, an arbitrary button (e.g., a power button) on the remote controller is pressed. This makes it possible to carry out pairing or reconnection of the remote controller and the television when the user wants to operate the television.

### [More Specific Configuration of Operation Target Apparatus 200]

The following describes a more specific configuration of the operation target apparatus 200 and the remote operation apparatus 300 with reference to FIG. 1. FIG. 1 is a block diagram illustrating a main configuration of the operation target apparatus 200 and the remote operation apparatus 300. As shown in FIG. 1, the operation target apparatus control section 203 includes an operated-side pairing executing section (operated-side pairing executing means) 1, an operated-side connection destination management section 2, and an operated-side communication control section 3. In the operation target apparatus storage section 207, a connection destination management table 4 is stored.

The operated-side pairing executing section 1 controls execution of a pairing process of the operation target apparatus 200. Specifically, when the operated-side pairing executing section 1 receives a pairing start signal from the remote operation apparatus 300, the operated-side pairing executing section 1 executes a pairing process in which the remote operation apparatus 300 and the operation target apparatus 200 register each other's addresses for carrying out Bluetooth communication.

The operated-side communication control section 3 controls communication with the remote operation apparatus 300 which is already paired with the operation target apparatus 200. That is, in a case where the operated-side communication control section 3 receives a connection start signal via the operated-side first communication section 208, the operated-side communication control section 3 carries out, via the operated-side second communication section 209, transmission and reception of a signal with the remote operation apparatus 300 that is already paired with the operation target apparatus 200. More specifically, when the operated-side communication control section 3 receives the connection start signal, the operated-side communication control section 3 transmits a connection request signal to the remote operation apparatus 300 via the operated-side second communication section 209 in order to request the remote operation apparatus 300 that is already paired with the operation target apparatus 200 to establish communication connection with each other through designation of each other's communication addresses via the operated-side second communication section 209. The remote operation apparatus 300 which has received the connection request signal transmits a connection permission signal to the operation target apparatus 200, and thereby Bluetooth communication connection is established between the remote operation apparatus 300 and the operation target apparatus 200. In a case where the operated-side communication control section 3 is controlled by a plurality of remote operation apparatuses 300, the operated-side communication control section 3 carries out a remote controller restriction setting process for restricting control items to be permitted for each of the remote operation apparatuses 300.

The operated-side connection destination management section 2 manages communication that is carried out via the operated-side second communication section 209. That is, the operated-side connection destination management section 2 manages information regarding a communication partner apparatus that is communicated with the operation target apparatus 200 via Bluetooth communication. Moreover, the operated-side connection destination management section 2 manages a communication partner apparatus which is concurrently being connected with the operation target apparatus 200 via Bluetooth communication. Specifically, the operated-side connection destination management section 2 stores, in the connection destination management table 4, an address, service information, and the like transmitted from the remote operation apparatus 300 in the pairing process. In a case where the operated-side connection destination management section 2 receives a connection start signal, the operated-side connection destination management section 2 judges whether or not a remote operation apparatus which has transmitted the connection start signal is registered in the connection destination management table 4.

Moreover, the operated-side connection destination management section 2 assigns IDs to respective apparatuses that are paired with the operation target apparatus 200. The IDs are also stored in the connection destination management table 4 and used (i) for identifying an apparatus connected with the operation target apparatus 200 and (ii) in the remote controller restriction setting process.

For example, the connection destination management table 4 can have a data structure as shown in Table 1 below. Table 1 is a table showing an example of the connection destination management table 4. Table 1 shows an example where (i) a remote controller ID, apparatus information, and service information are stored for each remote operation apparatus and (ii) the remote controller ID, apparatus information, and service information are associated with each other.

TABLE 1

| Remote Controller | Apparatus | Service |
|---|---|---|
| ID | Information | Information |
| 0x01 | 00:11:22:33:66:AA | 0x0001111 |
| | | (Remote control |
| | | service) |
| 0x02 | 00:11:22:33:55:AA | 0x0001111 |
| | | (Remote control |
| | | service) |
| . . . | . . . | . . . |

Table 1 shows an example of data stored in the connection destination management table 4 in a case where (i) a first remote operation apparatus which has a remote controller ID “0x01”, apparatus information (address for Bluetooth communication) “00:11:22:33:66:AA”, and service information “0x0001111” and (ii) a second remote operation apparatus which has a remote controller ID “0x02”, apparatus information “00:11:22:33:55:AA”, and service information “0x0001111” are already paired with the operation target apparatus 200.

The remote controller ID is identification information given to a paired apparatus which is paired with the operation target apparatus 200, the apparatus information is an address for carrying out Bluetooth communication, and the service information indicates service which the paired apparatus provides to the operation target apparatus 200. In the present embodiment, it is assumed that the operation target apparatus 200 is remotely operated by the remote operation apparatus 300. Accordingly, each of the services indicated by the service information is remote control service.

The operation target apparatus 200 can be connected, via Bluetooth connection, with various electronic devices such as a headphone as well as the remote operation apparatus 300. Accordingly, the operation target apparatus 200 needs to grasp what service the paired apparatus provides. This is the reason why the connection destination management table 4 shown in the example of Table 1 includes the service information.

Note that the connection destination management table 4 does not necessarily need to store the remote controller ID and the service information as long as the connection destination management table 4 includes at least the apparatus information. However, when the remote controller ID is stored in the connection destination management table 4, the operation target apparatus 200 can be remotely operated by a plurality of remote operation apparatuses, and when the service information is stored in the connection destination management table 4, a plural types of external devices can be connected to the operation target apparatus 200 via Bluetooth connection. Therefore, it is preferable that the connection destination management table 4 includes the remote controller ID and the service information.

### [More Specific Configuration of Remote Operation Apparatus 300]

As shown in FIG. 1, the remote operation apparatus control section 306 includes a connection start section 11, an operating-side communication control section (operating-side communication control means) 12, an operating-side connection destination management section 13, an operated-side pairing executing section (operating-side pairing executing means) 14, and a pairing start section (pairing start means) 17. The remote operation apparatus storage section 310 includes a connection destination storage section 15 and an identification information storage section 16.

The connection start section 11 controls start timing of a reconnection process in which communication connection is carried out after the remote operation apparatus 300 and the operation target apparatus 200 are paired with each other. In the reconnection process, Bluetooth communication connection is established between the remote operation apparatus 300 and the operation target apparatus 200. Specifically, when a predetermined input operation is carried out on the operating section 308, the connection start section 11 (i) instructs the operating-side first communication section 301 to transmit, to the operation target apparatus 200, a connection start signal for starting Bluetooth communication connection and (ii) instructs the operating-side communication control section 12 to cause the remote operation apparatus 300 to shift to a connection request awaiting mode.

Note that the predetermined input operation is an input operation carried out when a user of a remote operation apparatus 300 uses the remote operation apparatus 300 as a remote controller. For example, in the example of FIG. 4, an operation for selecting an apparatus to be connected corresponds to the predetermined input operation. Moreover, in the example of FIG. 6, the predetermined input operation corresponds to an operation for setting the selector switch to a connection target apparatus, or input operations of arbitrary input buttons such as the power button or operation buttons for operating the operation target apparatus 200 in the state where the selector switch is being set to the connection target apparatus.

As described above, the reconnection process is triggered by an input operation carried out when the user of the remote operation apparatus 300 uses the remote operation apparatus 300 as a remote controller. Accordingly, the user can remotely operate the operation target apparatus 200 in a similar manner to a conventional general infrared remote controller.

Note that it is possible that a reconnection process executing key is provided in the remote operation apparatus 300, and the connection start section 11 instructs the operating-side first communication section 301 to transmit a connection start signal when an input operation is carried out on the reconnection process executing key. Moreover, it is also possible, for example, that an image for carrying out an input operation for transmitting a connection start signal is displayed, and a user carries out an input operation for transmitting a connection start signal in accordance with the screen.

However, when the number of keys for operation is increased, operability for the user is decreased. Therefore, it is preferable that transmission of a connection start signal is triggered by an input operation carried out when the remote operation apparatus 300 is used as a remote controller, as described above.

Based on an ID, stored in the identification information storage section 16, of the remote operation apparatus 300 in which the connection start section 11 is included, the connection start section 11 generates a connection start signal with which the operation target apparatus 200 can identify an apparatus which has transmitted the connection start signal. For example, the operation target apparatus 200 can identify an apparatus which has transmitted a connection start signal when an ID of the apparatus is incorporated in the connection start signal.

With the configuration, the operation target apparatus 200 can recognize from which remote operation apparatus the operation target apparatus 200 has received a connection start signal even in a case where the operation target apparatus 200 is paired with a plurality of apparatuses. As a result, the operation target apparatus 200 can certainly be connected with an apparatus which has transmitted the connection start signal.

The operating-side communication control section 12 generates a command in accordance with an input operation on the operating section 308. Then, the operating-side communication control section 12 instructs the operating-side second communication section 302 to transmit the command thus generated to an address stored in the connection destination storage section 15, that is, to the operation target apparatus 200 which is communication-connected with the remote operation apparatus 300 via the operating-side second communication section 302.

Moreover, the operating-side communication control section 12 controls communication carried out via the operating-side second communication section 302 with the operation target apparatus 200 which is already paired with the remote operation apparatus 300. Specifically, the operating-side communication control section 12 shifts to the connection request awaiting mode in response to an instruction from the connection start section 11, and awaits a connection request from the operation target apparatus 200. Then, in a case where the operating-side communication control section 12 confirms a reception of a connection request, the operating-side communication control section 12 executes a reconnection process for establishing communication connection, via the operating-side second communication section 302, between the remote operation apparatus 300 and the operation target apparatus 200 which has transmitted the connection request.

Note that the connection request awaiting mode indicates a state where the operating-side communication control section 12 receives a connection request and executes the reconnection process. In a case where the operating-side communication control section 12 confirms a connection request when the operating-side communication control section 12 is not in the connection request awaiting mode, a reconnection process is not executed. With the configuration, even in a case where the operation target apparatus 200 is operated by a plurality of remote operation apparatuses 300, communication connection can be certainly established between one of the remote operation apparatuses 300 which has transmitted a connection start signal and the operation target apparatus 200 which has received the connection start signal.

Note that duration time of the connection request awaiting mode is set so that a connection request can be received only during a predetermined period of time after the connection start section 11 transmits a connection start signal. The predetermined period of time is not limited in particular as long as the predetermined period of time is secured enough for the remote operation apparatus 300 to receive a connection request from the operation target apparatus 200 which has received the connection start signal. For example, the predetermined period of time can be approximately 30 seconds.

The operating-side connection destination management section 13 manages communication that is carried out via the operating-side second communication section 302, that is, information regarding an apparatus to be communicated via Bluetooth communication. Specifically, the operating-side connection destination management section 13 stores, in the connection destination storage section 15, an address transmitted from the operation target apparatus 200 in a pairing process.

Moreover, the operating-side connection destination management section 13 manages identification information which the operated-side connection destination management section 2 of the operation target apparatus 200 has assigned to the remote operation apparatus 300, that is, manages a remote controller ID. Specifically, according to the remote operation system 100, the operation target apparatus 200 is to transmit a remote controller ID to an apparatus to be paired. Accordingly, the operating-side connection destination management section 13 receives the remote controller ID and stores the remote controller ID in the identification information storage section 16. Moreover, in a case where the operating-side connection destination management section 13 receives a connection request, the operating-side connection destination management section 13 judges whether or not an address of an apparatus (e.g., operation target apparatus 200) which has transmitted the connection request is stored in the connection destination storage section 15.

The pairing start section 17 controls start timing of pairing. Specifically, in a case where a predetermined input operation is carried out on the operating section 308, the pairing start section 17 (i) instructs the operating-side first communication section 301 to transmit a pairing start signal and (ii) instructs the operating-side pairing executing section 14 to cause the remote operation apparatus 300 to shift to the pairing mode.

Note that the predetermined input operation is an input operation carried out when a user of a remote operation apparatus 300 uses the remote operation apparatus 300 as a remote controller. For example, in the example of FIG. 4, an operation for selecting an apparatus to be connected corresponds to the predetermined input operation. Moreover, in the example of FIG. 6, the predetermined input operation corresponds to an operation for setting the selector switch to a connection target apparatus, or input operations of arbitrary input buttons such as the power button in the state where the selector switch is being set to the connection target apparatus.

These examples are preferable because the user does not need to carry out any special operation for the pairing, as long as the pairing is triggered by an input operation carried out when a user of a remote operation apparatus 300 uses the remote operation apparatus 300 as a remote controller.

Conventionally, for example, a pairing button provided on an operation target apparatus needs to be pressed for causing the operation target apparatus to shift to a pairing mode. Further, for carrying out pairing, a pairing button provided on a remote operation apparatus needs to be pressed while the operation target apparatus is in the pairing mode.

On the other hand, according to the present embodiment, in a case where pairing is triggered by an input operation carried out when a user of a remote operation apparatus 300 uses the remote operation apparatus 300 as a remote controller, the user does not need to carry out any special operation for pairing, and the user can carry out the pairing in a similar manner to a conventional general infrared remote controller.

Note that it is possible that a pairing executing key is provided in the remote operation apparatus 300, and the pairing start section 17 instructs the operating-side first communication section 301 to transmit a pairing start signal when an input operation is carried out on the pairing executing key. Moreover, it is also possible, for example, that an image for carrying our an input operation for transmitting a pairing start signal is displayed, and a user carries out an input operation for transmitting a pairing start signal in accordance with the screen.

However, when the number of keys for operation is increased, operability for the user is decreased. Therefore, it is preferable that transmission of a pairing start signal is triggered by an input operation carried out when the remote operation apparatus 300 is used as a remote controller, as described above.

The operating-side pairing executing section 14 controls execution of a pairing process in the remote operation apparatus 300. Specifically, when the operating-side pairing executing section 14 receives an instruction from the pairing start section 17, the operating-side pairing executing section 14 executes a pairing process in which the remote operation apparatus 300 and the operation target apparatus 200 register each other's addresses for carrying out Bluetooth communication.

[Process Flow in Remote Operation System 100 (Remote Operation Apparatus 300 Side)]

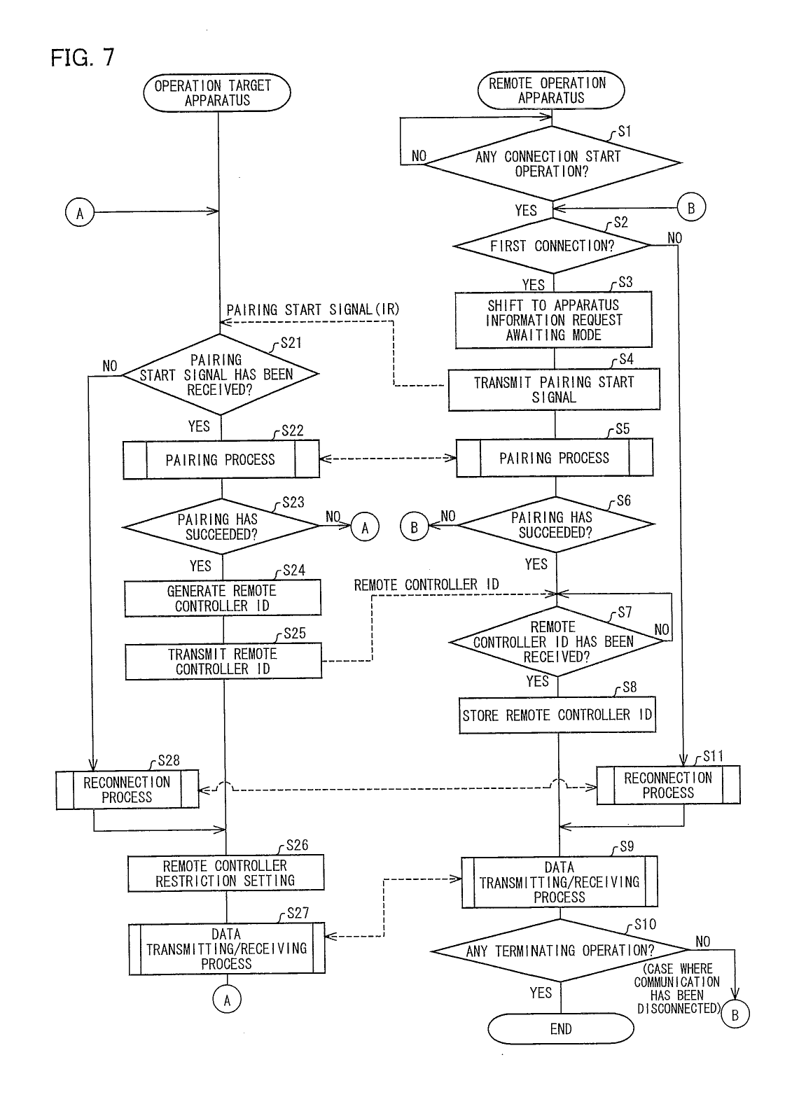

The following describes, with reference to FIG. 7, a process flow in the remote operation system 100 including the operation target apparatus 200 and the remote operation apparatus 300 which have the above-described configurations. FIG. 7 is a flowchart illustrating an example of processes in the remote operation system 100. First, a process flow carried out by the remote operation apparatus 300 is discussed, and subsequently a process flow carried out by the operation target apparatus 200 is discussed.

As described above, the remote operation apparatus 300 can remotely operate the remote operation apparatus 300 by activating the remote controller application. When the remote controller application is activated, the pairing start section 17 confirms whether or not a connection start operation is carried out (S1). The connection start operation is an input operation for starting a remote operation of the operation target apparatus 200 by the remote operation apparatus 300. The connection start operation corresponds to the operation for selecting a type of an apparatus in the example shown in FIG. 4.

Then, when a connection start operation is confirmed (YES in S1), the pairing start section 17 confirms whether or not connection is to be carried out for the first time (S2). Note that, in a case where connection is to be carried out for the first time, pairing is not carried out yet. For example, it is possible to judge whether or not connection is to be carried out for the first time based on whether or not an address of a paired apparatus is stored in the connection destination storage section 15.

In a case where the connection is not the first connection (NO in S2), it is not necessary to carry out pairing. Accordingly, the process proceeds on to S11, and a reconnection process is carried out for establishing Bluetooth communication connection with the paired apparatus. On the other hand, in a case where the connection is the first connection (YES in S2), it is necessary to carry out pairing, and accordingly the pairing start section 17 sets the operating-side pairing executing section 14 to an apparatus information request awaiting mode (S3).

Note that the apparatus information request awaiting mode is a state where pairing with the remote operation apparatus 300 can be carried out (pairing mode). When an address is received during the apparatus information request awaiting mode, the address is registered in the connection destination storage section 15 as an apparatus to be communicated with the remote operation apparatus 300 via Bluetooth communication.

Moreover, the pairing start section 17 (i) sets the operating-side pairing executing section 14 to the apparatus information request awaiting mode and (ii) instructs the operating-side first communication section 301 to transmit a pairing start signal (S4). The remote operation apparatus 300 transmits a pairing start signal via directional infrared communication, and whereby pairing can be carried out only with an operation target apparatus 200 to which the remote operation apparatus 300 is pointed.

The pairing start signal can have a data structure as shown in Table 2 below, for example. Note that the pairing start signal is not limited to the example of Table 2 as long as the operation target apparatus 200 can recognize the pairing start signal as an instruction to start pairing. However, it is preferable that the pairing start signal has a data format specified by Association for Electric Home Appliances. When the pairing start signal has a data format specified by Association for Electric Home Appliances, a configuration used in a conventional general infrared remote controller can be used as the operating-side first communication section 301 without modification.

TABLE 2

| Type | Data | Meaning |
|---|---|---|
| Pairing start signal | 0xAAAA 8888 1234 | Start pairing |

The transmission of the pairing start signal in S4 causes the operation target apparatus 200 which has received the pairing start signal to be paired with the remote operation apparatus 300 (S5). Although details are described later, in the pairing process, apparatus information (address for Bluetooth communication) of the remote operation apparatus 300 is stored in the connection destination management table 4 of the operation target apparatus 200, and apparatus information (address for Bluetooth communication) of the operation target apparatus 200 is stored in the connection destination storage section 15 of the operation target apparatus 200.

Then, the pairing start section 17 confirms whether or not the pairing has been carried out successfully (S6). In a case where the pairing has failed (NO in S6), the process returns to S2. On the other hand, in a case where the pairing has succeeded (YES in S6), the pairing start section instructs the operating-side connection destination management section 13 to confirm whether or not a remote controller ID has been received (S7). Then, in a case where reception of a remote controller ID is confirmed (YES in S7), the pairing start section 17 instructs the operating-side connection destination management section 13 to cause the identification information storage section 16 to store the remote controller ID thus received (S8).

Through the processes S1 through S8, Bluetooth communication connection is established between the remote operation apparatus 300 and the operation target apparatus 200. This makes it possible to operate the operation target apparatus 200 by the remote operation apparatus 300, and accordingly a data transmitting/receiving process (details are described later) in S9 can be carried out.

Moreover, the processes S1 through S8 are started only by carrying out a connection start operation. The connection start operation is, for example, the operation for selecting a type of an apparatus to be connected in the example of FIG. 4, or a shifting operation of the selector switch or an operation on an arbitrary operation button in the example of FIG. 6. This allows a user of the remote operation apparatus 300 to operate the operation target apparatus 200 in a similar manner to a conventional general infrared remote controller, without being aware of pairing.

### [Process Flow in Remote Operation System 100 (Operation Target Apparatus 200 Side)]

The following describes a process flow carried out by the operation target apparatus 200 in the remote operation system 100. First, the operated-side pairing executing section 1 awaits a reception of a pairing start signal (S21).

In a case where the operated-side pairing executing section 1 receives a signal other than a pairing start signal (NO in S21), the operated-side pairing executing section 1 instructs the operated-side communication control section 3 to execute a reconnection process (S28). On the other hand, in a case where a reception of a pairing start signal is confirmed (YES in S21), the operated-side pairing executing section 1 starts a pairing process (S22).

In the pairing process, apparatus information (address for Bluetooth communication) of the remote operation apparatus 300 is stored in the connection destination management table 4 of the operation target apparatus 200 and apparatus information (address for Bluetooth communication) of the operation target apparatus 200 is stored in the connection destination storage section 15 of the operation target apparatus 200.

When the pairing process is ended, the operated-side pairing executing section 1 confirms whether or not the pairing has succeeded (S23). In a case where the pairing has failed (NO in S23), the process returns to S21. On the other hand, in a case where the pairing has succeeded (YES in S23), the operated-side pairing executing section 1 instructs the operated-side connection destination management section 2 to generate a remote controller ID (S24).

Note that a generation method and data contents of the remote controller ID are not limited in particular as long as the remote controller ID can identify an apparatus which has been paired successfully with the operation target apparatus 200. In the present embodiment, it is assumed that data of double hexadecimal digits, whose final number increases in the order of pairing, is generated as a remote controller ID, as shown in Table 1. That is, in the example of Table 1, the first apparatus which is paired with the operation target apparatus 200 is given a remote controller ID “0x01”, and the next apparatus which is paired with the operation target apparatus 200 is given a remote controller ID “0x02”.

Then, the operated-side communication control section 3 transmits the remote controller ID generated by the operated-side connection destination management section 2 to the remote operation apparatus 300 via the operated-side second communication section 209 (S25). Subsequently, the operated-side communication control section 3 carries out, if needed, a remote controller restriction setting process for setting restriction on items which can be operated by the remote operation apparatus 300 corresponding to the remote controller ID thus transmitted (S26). After the remote controller setting is terminated, the operated-side communication control section 3 carries out data transmitting/receiving process (S27). Details of the remote controller restriction setting process and the data transmitting/receiving process are described later.

Note that the pairing carried out in the remote operation system 100 does not necessarily need to be carried out in accordance with the flow shown in FIG. 7, as long as the apparatus information of the remote operation apparatus 300 is stored in the connection destination management table 4 of the operation target apparatus 200 and the apparatus information of the operation target apparatus 200 is stored in the connection destination storage section 15 of the operation target apparatus 200.

However, as shown in FIG. 7, when pairing is triggered by a pairing start signal transmitted as an infrared signal, the operation target apparatus 200 and the remote operation apparatus 300 can be paired with each other drastically easily. Therefore, it is preferable that the pairing of the operation target apparatus 200 and the remote operation apparatus 300 is carried out in accordance with the flow shown in FIG. 7.

### [Reconnection Process (Remote Operation Apparatus 300 Side)]

As described above, when the remote operation apparatus 300 and the operation target apparatus 200 are connected with each other for the first time, pairing is carried out (see S2 in FIG. 7). This makes it possible to carry out Bluetooth communication between the remote operation apparatus 300 and the operation target apparatus 200 through designation of each other's addresses.

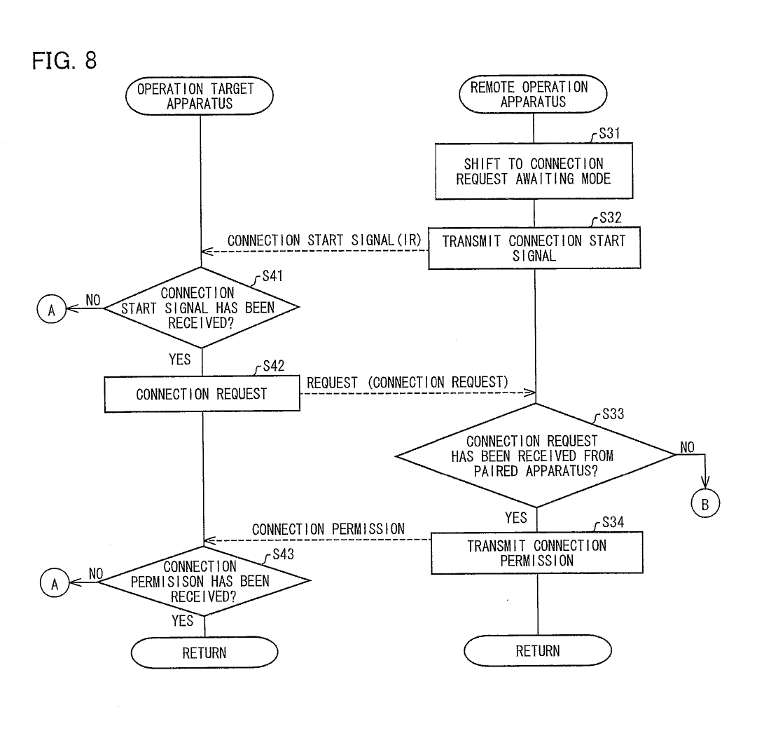

The following describes, with reference to FIG. 8, a reconnection process which is carried out when the remote operation apparatus 300 and the operation target apparatus 200 are connected for the second time or further, that is, when the remote operation apparatus 300 and the operation target apparatus 200 are already paired with each other. FIG. 8 is a flowchart illustrating an example of the reconnection process. The reconnection process corresponds to the processes in S11 and S28 in the flowchart shown in FIG. 7. First, a reconnection process carried out in the remote operation apparatus 300 in S11 of FIG. 7 is described, and subsequently a reconnection process carried out in the operation target apparatus 200 in S28 is described.

Note that the reconnection process carried out after the pairing is ended is not limited to the example of FIG. 8 but a general connection process method carried out between paired apparatuses can be used.

The reconnection process is carried out when the pairing start section 17 determines that a connection is not the first connection (see S2 and S11 in FIG. 7). In a case where the pairing start section 17 determines that a connection is not the first connection, the pairing start section 17 informs the connection start section 11 that the connection is not the first connection. The connection start section 11 thus informed sets the operating-side communication control section 12 to a connection request awaiting mode (S31). When the operating-side communication control section 12 is set to the connection request awaiting mode, the operating-side communication control section 12 comes to be ready for Bluetooth communication. In a case where the operating-side communication control section 12 receives a connection request from the operation target apparatus 200 after the operating-side communication control section 12 is set to the connection request awaiting mode, a reconnection process is carried out.

That is, in a case where the operating-side communication control section 12 confirms a reception of a connection request from the operation target apparatus 200 during duration time of the connection request awaiting mode, the reconnection process is carried out. On the other hand, a connection request is not received when the operating-side communication control section 12 is not in the connection request awaiting mode (even though a connection request is received, a reconnection process is not carried out).

The connection start section 11 instructs the operating-side first communication section 301 to transmit a connection start signal outside of the remote operation apparatus 300 (S32). In this way, the remote operation apparatus 300 transmits a connection start signal via directional infrared communication. Therefore, the remote operation apparatus 300 can be connected to only an apparatus to which the remote operation apparatus 300 is pointed, and thereby carrying out communication.

Note that, in order for the operation target apparatus 200 which has received a connection start signal to judge from which remote operation apparatus 300 the operation target apparatus 200 has received the operation signal, the connection start section 11 transmits a connection start signal containing identification information (remote controller ID) assigned to the remote operation apparatus 300. The connection start signal can be, for example, data as shown in Table 3 below.

Table 3 illustrates data examples of connection start signals (1) through (3) which are transmitted from three remote operation apparatuses which are given remote controller IDs “0x01”, “0x02”, and “0x03”, respectively. In the example of Table 3, final two digits of data of each of the connection start signals are identical to those of a corresponding remote controller ID. Accordingly, based on one of the connection start signals (1) through (3) which the operation target apparatus 200 receives, the operation target apparatus 200 can recognize one of the remote operation apparatuses having remote controller IDs “0x01”, “0x02”, and “0x03” which one has transmitted a connection start signal.

TABLE 3

| Type | Data | Meaning |
|---|---|---|
| Connection start | 0xAAAA 8888 2201 | Connection start signal |
| signal (1) | | (Remote controller ID: |
| | | 0x01) |
| Connection start | 0xAAAA 8888 2202 | Connection start signal |
| signal (2) | | (Remote controller ID: |
| | | 0x02) |
| Connection start | 0xAAAA 8888 2203 | Connection start signal |
| signal (3) | | (Remote controller ID: |
| | | 0x03) |

After the operating-side communication control section 12 causes the operating-side first communication section 301 to transmit the connection start signal, the operating-side communication control section 12 confirms whether or not a connection request is transmitted from the paired apparatus during the duration time of the connection request awaiting mode (S33). In the present embodiment, it is assumed that the connection request transmitted from the operation target apparatus 200 contains an address of the operation target apparatus 200 and whereby the operating-side connection destination management section 13 can confirm whether or not a connection request is transmitted from the paired apparatus. Note that the connection request is not limited to this example as long as the remote operation apparatus 300 can identify an apparatus which has transmitted the connection request.

In a case where a connection request cannot be confirmed (NO in S33), the process returns to S2 in FIG. 7. On the other hand, in a case where a connection request is confirmed (YES in S33), the operating-side communication control section 12 instructs the operating-side second communication section 302 to send a connection permission to the operation target apparatus 200 (S34), and ends the reconnection process. When the reconnection process is ended, the process is shifted to S9 in FIG. 7 and a data transmitting/receiving process is carried out.

Note that the connection request and the connection permission can be, for example, data as shown in Table 4 below. Table 4 illustrates an example of data of the connection request and the connection permission. As shown in Table 4, each of the connection request and the connection permission includes addresses of a transmission source terminal and a transmission destination terminal of the connection request and the connection permission. This allows the remote operation apparatus 300 which has received a connection request to send back a connection permission to the operation target apparatus 200 which has transmitted the connection request.

TABLE 4

| | | Source | Destination | |
|---|---|---|---|---|
| Type | Data | Address | Address | Meaning |
| Connection | REQUEST_CONNECT | 00:11:22:33:44:AA | 00:11:22:33:66:AA | Request |
| request | | | | connection |
| | | | | with |
| | | | | operation |
| | | | | target |
| | | | | apparatus |
| Connection | ACCEPT_CONNECT | 00:11:22:33:66:AA | 00:11:22:33:44:AA | Permit |
| permission | | | | connection |
| | | | | with |
| | | | | operation |
| | | | | target |
| | | | | apparatus |

[Reconnection Process (Operation Target Apparatus 200 Side)]

The following describes, with reference to FIG. 8, a reconnection process carried out by the operation target apparatus 200 in S28 in the flowchart of FIG. 7. First, the operated-side communication control section 3 confirms whether or not a connection start signal has been received (S41). In a case where a reception of a connection start signal cannot be confirmed (NO in S41), the operated-side communication control section 3 returns to the process of S21 in FIG. 7. On the other hand, in a case where a reception of a connection start signal is confirmed (YES in S41), the operated-side communication control section 3 instructs the operating-side second communication section 302 to transmit a connection request (S42).

In the present embodiment, it is assumed that part of a remote controller ID is included in a connection start signal (see Table 3). Moreover, as shown in Table 1, it is assumed that a remote controller ID and apparatus information (address) which are associated with each other are stored in the connection destination management table 4. This allows the operated-side connection destination management section 2 to judge whether or not an apparatus which has transmitted the connection start signal is registered in the connection destination management table 4. Further, this allows the operated-side communication control section 3 to specify an address of the apparatus which has transmitted the connection start signal and to transmit a connection request to the address.

Note that, in the reconnection process, the remote operation apparatus 300 shifts to the connection request awaiting mode (S31 in FIG. 7). Therefore, it is possible to establish Bluetooth communication between the operation target apparatus 200 and the remote operation apparatus 300 even though a remote controller ID is not included in a connection start signal.

The operated-side communication control section 3 which has issued an instruction to transmit the connection request awaits a reception of a connection permission (S43). In a case where a reception of a connection permission is not confirmed within a predetermined time (NO in S43), the operated-side communication control section 3 returns to the process of S21 in FIG. 7. On the other hand, in a case where a reception of a connection permission is confirmed (YES in S43), the operated-side communication control section 3 terminates the reconnection process. When the reconnection process is terminated, the process is shifted to S26 in FIG. 7, and a data transmitting/receiving process is carried out.

### [Pairing Process (Operation Target Apparatus 200 Side)]

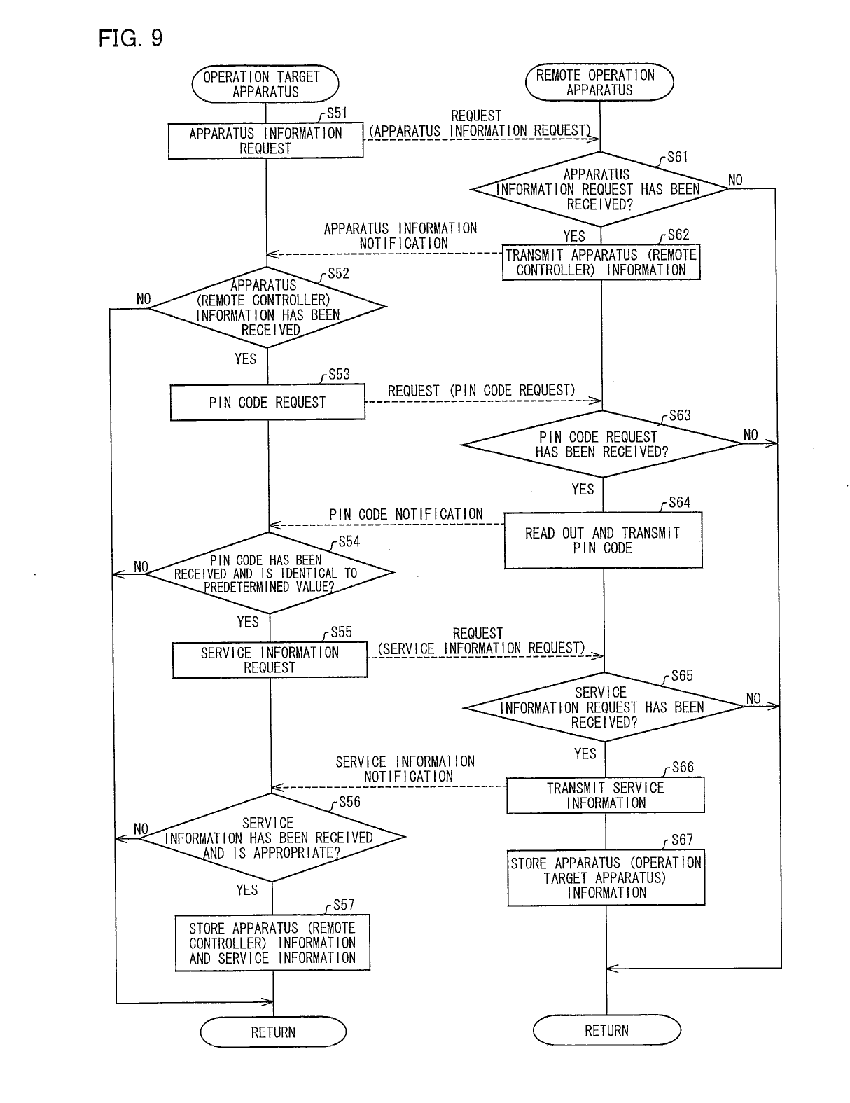

The following describes details of a pairing process carried out in S5 and S22 in the flowchart of FIG. 7, with reference to FIG. 9. FIG. 9 is a flowchart showing an example of the pairing process. First, a pairing process carried out in the operation target apparatus 200 in S22 of the flowchart of FIG. 7 is described. Subsequently, a pairing process carried out in the remote operation apparatus 300 in S5 of the flowchart of FIG. 7 is described.

When the operated-side pairing executing section 1 of the operation target apparatus 200 confirms a reception of a pairing start signal, the operated-side pairing executing section 1 starts a pairing process. Specifically, the operated-side pairing executing section 1 instructs the operated-side second communication section 209 to transmit an apparatus information request (S51). Note that the apparatus information request is information including an address of a terminal which has transmitted the apparatus information request, that is, an address of the operation target apparatus 200. Accordingly, the remote operation apparatus 300 which has received the apparatus information request can register the operation target apparatus 200 as a terminal with which Bluetooth communication is carried out.

Moreover, the apparatus information requests are transmitted to all apparatuses within the Bluetooth communication of the operation target apparatus 200. At this point, the remote operation apparatus 300 is in an apparatus information request awaiting mode (S3 in FIG. 7). Accordingly, the operation target apparatus 200 can cause the remote operation apparatus 300 to certainly receive the apparatus information request.

The operated-side pairing executing section 1 which has caused the operated-side second communication section 209 to transmit the apparatus information request awaits apparatus information to be transmitted from the remote operation apparatus 300 (S52). In a case where a reception of apparatus information cannot be confirmed within a predetermined period of time (NO in S52), the operated-side pairing executing section 1 terminates the pairing process. In this case, the process in the flowchart in FIG. 7 proceeds from S22 to S23 where it is determined that a pairing has failed, and then the process returns to S21.

On the other hand, in a case where a reception of the apparatus information is confirmed within a predetermined period of time (YES in S52), the operated-side pairing executing section 1 instructs the operated-side second communication section 209 to transmit a PIN code request to the remote operation apparatus 300 (S53), and awaits a reception of a PIN code (S54). In a case where a reception of a PIN code cannot be confirmed within a predetermined period of time, or a case where a received PIN code is different form a predetermined value (NO in S54), the operated-side pairing executing section 1 merely terminates the process. In this case, the process of the flowchart of FIG. 7 shifts from S22 to S23 where it is determined that a pairing has failed, and then the process returns to S21.

On the other hand, in a case where a received PIN code is identical to a predetermined value (YES in S54), the operated-side pairing executing section 1 instructs the operated-side second communication section 209 to transmit a service information request to the remote operation apparatus 300 (S55), and awaits a reception of service information (S56).

Note that the PIN code is a code set so that the operation target apparatus 200 does not receive a control from a remote operation apparatus 300 which is not intended by the user. That is, in the operation target apparatus 200, a PIN code is set in advance with respect to a remote operation apparatus 300 which is permitted to control the operation target apparatus 200. Accordingly, in a case where a PIN code transmitted from a remote operation apparatus 300 to be connected is identical to a PIN code set in the operation target apparatus 200, a connection with the remote operation apparatus 300 is to be permitted.

In a case where a reception of service information cannot be confirmed within a predetermined period of time, or a case where received service information is not appropriate (NO in S56), the operated-side pairing executing section 1 merely terminates the process. In this case, the process of the flowchart of FIG. 7 shifts from S22 to S23 where it is determined that a pairing has failed, and then the process returns to S21. Note that appropriateness of service information is judged depending on whether or not a service corresponding to the service information is available in the operation target apparatus 200.

In a case where received service information is appropriate (YES in S56), the operated-side pairing executing section 1 stores the apparatus information of the remote operation apparatus 300 which apparatus information is confirmed to be received in S52 and the service information received in S57, and terminates the process (S57). In this case, the process of the flowchart of FIG. 7 shifts from S22 to S23 where it is determined that a pairing has succeeded, and then the process shifts to S24.

Note that the apparatus information request, the PIN code request, the service information request, the apparatus information, the PIN code, and the service information can be, for example, data shown in Table 5 below. As shown in Table 5, in Bluetooth communication, data is basically transmitted together with addresses of a transmission source and a transmission destination of the data. This allows the remote operation apparatus 300 and the operation target apparatus 200 to carry out communication with each other even in a case where other Bluetooth-applicable devices are present within the Bluetooth communication range.

TABLE 5

| | | Source | Destination | |
|---|---|---|---|---|
| Type | Data | Address | Address | Meaning |
| Apparatus | REQUEST_DEVICE_INFO | 00:11:22:33:44:AA | | Request |
| information | | | | apparatus |
| request | | | | information of |
| | | | | remote |
| | | | | operation |
| | | | | apparatus |
| PIN code | REQUEST_PIN_INFO | 00:11:22:33:44:AA | 00:11:22:33:66:AA | Request |
| request | | | | transmission |
| | | | | of PIN code |
| Service | REQUEST_SERVICE_INFO | 00:11:22:33:44:AA | 00:11:22:33:66:AA | Request |
| information | | | | service |
| request | | | | information |
| | | | | from remote |
| | | | | operation |
| | | | | apparatus |
| Apparatus | 00:11:22:33:66:AA | 00:11:22:33:66:AA | 00:11:22:33:44:AA | Address of |
| information | | | | Apparatus |
| (Remote | | | | |
| controller) | | | | |
| PIN code | 9999 | 00:11:22:33:66:AA | 00:11:22:33:44:AA | PIN code |
| Service | 0x00001111 | 00:11:22:33:66:AA | 00:11:22:33:44:AA | Service |
| Information | | | | identification |
| | | | | name (Remote |
| | | | | control |
| | | | | service) |

[Pairing Process (Remote Operation Apparatus 300 Side)]

The following describes, with reference to FIG. 9, a pairing process carried out by the remote operation apparatus 300 in S5 of the flowchart of FIG. 7. Specifically, the operating-side pairing executing section 14 of the remote operation apparatus 300 awaits a apparatus information request (S61). In a case where a reception of apparatus information cannot be confirmed within a predetermined period of time (e.g., within 30 seconds) (NO in S61), the operating-side pairing executing section 14 cancels the apparatus information request awaiting mode and terminates the pairing process. This makes it possible to prevent pairing of the remote operation apparatus 300 and an electronic apparatus which is not intended by the user. In this case, the process of the flowchart of FIG. 7 shifts from S5 to S6 where it is determined that a pairing has failed, and then the process returns to S2.

On the other hand, in a case where a reception of apparatus information can be confirmed (YES in S61), the operating-side pairing executing section 14 instructs the operating-side second communication section 302 to transmit apparatus information (address) of the remote operation apparatus 300 (S62), and then awaits a reception of a PIN code request (S63).

In a case where a reception of a PIN code request cannot be confirmed within a predetermined period of time (NO in S63), the operating-side pairing executing section 14 merely terminates the process. In this case, the process of the flowchart of FIG. 7 shifts from S5 to S6 where it is determined that a pairing has failed, and then the process returns to S2.

On the other hand, in a case where a reception of a PIN code request is confirmed (YES in S63), the operating-side pairing executing section 14 reads out a PIN code which is stored in the remote operation apparatus storage section 310 in advance, and instructs the operating-side second communication section 302 to transmit the PIN code thus read out to the operation target apparatus 200 (S64).

In a case where matching of a PIN code succeeds, the operated-side pairing executing section 1 is to transmit a service information request in the process of S56. After giving the instruction to transmit the PIN code in S64, the operating-side pairing executing section 14 confirms whether or not a service information request has been received (S65). In a case where a reception of a service information request cannot be confirmed (NO in S65), the operating-side pairing executing section 14 merely terminates the process. In this case, the process of the flowchart of FIG. 7 shifts from S5 to S6 where it is determined that a pairing has failed, and then the process returns to S2.

On the other hand, in a case where a reception of a service information request is confirmed (YES in S65), the operating-side pairing executing section 14 instructs the operating-side second communication section 302 to transmit service information to the operation target apparatus 200 (S66). Then, finally, the operating-side pairing executing section 14 (i) stores, in the connection destination storage section 15, apparatus information (address) of the operation target apparatus 200 which apparatus information is included in the apparatus information request received in S61, and (ii) terminates the process. In this case, the process of the flowchart of FIG. 7 shifts from S5 to S6 where it is determined that a pairing has succeeded, and then the process shifts to S7.

As described above, in the pairing process, the apparatus information (address) of the operation target apparatus 200 is stored in the connection destination storage section 15 of the remote operation apparatus 300, and the apparatus information (address) of the remote operation apparatus 300 is stored in the connection destination management table 4 of the operation target apparatus 200. This allows the remote operation apparatus 300 and the operation target apparatus 200 to carry out Bluetooth communication afterward, through designation of the each other's addresses. Note that the pairing process is not limited to the above described example, as long as the apparatus information of the operation target apparatus 200 is stored in the remote operation apparatus 300 and the apparatus information of the remote operation apparatus 300 is stored in the operation target apparatus 200.

For example, in the above described example, the operation target apparatus 200 transmits, to the remote operation apparatus 300, the device information request along with the communication address of the operation target apparatus 200, and the remote operation apparatus 300 which has received the apparatus information request transmits the apparatus information (communication address) of the remote operation apparatus 300 to the operation target apparatus 200. However, it is possible that the remote operation apparatus 300 transmits, to the operation target apparatus 200, an apparatus information request along with a communication address of the remote operation apparatus 300.

In this case, the remote operation apparatus 300 does not carry out the process of S3 of FIG. 7 but the operation target apparatus 200 which has received the pairing start signal shifts to the apparatus information request awaiting mode. Then, the remote operation apparatus 300 transmits the apparatus information request along with the communication address of the remote operation apparatus 300 to the operation target apparatus 200 which has shifted to the apparatus information request awaiting mode. This allows the remote operation apparatus 300 to obtain the apparatus information of the operation target apparatus 200. With the configuration also, pairing of the remote operation apparatus 300 and the operation target apparatus 200 can be carried out.

Moreover, in this case, in a case where a reception of apparatus information cannot be confirmed within a predetermined period of time (e.g., 30 seconds) after the operation target apparatus 200 shifts to the apparatus information request awaiting mode, it is possible that the apparatus information request awaiting mode is canceled and the pairing process is terminated. This makes it possible to prevent pairing of the operation target apparatus 200 and an electronic apparatus which is not intended by the user.

### [Remote Controller Restriction Setting]

The following describes details of the remote controller restriction setting carried out in S26 of the flowchart in FIG. 7. As described above, in the remote operation system 100, a plurality of remote operation apparatuses can operate a single operation target apparatus 200. In this case, conflict among commands transmitted from the plurality of remote operation apparatuses may occur. For example, in a case where one of the remote operation apparatuses transmits a command to change the channel to “8” but another one of the remote operation apparatuses transmits a command to change the channel to “10”, an output channel of the operation target apparatus 200 is changed many times in a short time, and therefore this is not preferable.

In order to prevent this, in a case where the operation target apparatus 200 is connected with a plurality of remote operation apparatuses via Bluetooth communication, the operated-side communication control section 3 of the operation target apparatus 200 carries out a remote controller restriction setting for restricting processes which can be controlled by each of the remote operation apparatuses.

Specifically, in a case where the operated-side communication control section 3 receives a command from a remote operation apparatus, the operated-side communication control section 3 instructs the operated-side connection destination management section 2 to confirm whether or not the remote operation apparatus which has transmitted the command is given the highest priority among the remote operation apparatuses which are being connected. Note that, for example, levels of the priority can be set based on the connection order, or can be set by the user in advance.

In a case where the remote operation apparatus which has transmitted the command is given the highest priority among the remote operation apparatuses which are being connected, the operated-side communication control section 3 activates all commands from the remote operation apparatus. That is, in this case, no restriction is set to commands from the remote operation apparatus and accordingly the operation target apparatus 200 operates in accordance with all the commands from the remote operation apparatus.

On the other hand, in a case where the remote operation apparatus which has transmitted the command does not have the highest priority among the remote operation apparatuses which are being connected, the operated-side communication control section 3 causes at least part of commands from the remote operation apparatus not to be executed by the operation target apparatus 200. This makes it possible to prevent conflict among commands transmitted from the plurality of remote operation apparatuses.

Note that, in this embodiment, it is assumed that a command transmitted by a remote operation apparatus 300 includes an address of the remote operation apparatus 300 which has transmitted the command. This allows an operation target apparatus 200 to specify the remote operation apparatus 300 which has transmitted the command and to determine whether or not to set a restriction on the command.

It is preferable that the operated-side communication control section 3 set restrictions on commands for changing outputs, such as changing channels and changing sound volume, of the operation target apparatus 200. On the other hand, it is not particularly necessary to set restrictions on commands which do not change outputs of the operation target apparatus 200. Such commands can be commands which cause the operation target apparatus 200 to transmit, to the remote operation apparatus 300, information held in the operation target apparatus 200 such as contents of a television program which is being outputted and a television program listing. Moreover, it is possible to set respective restrictions, as appropriate, on the plurality of remote operation apparatuses which are being connected concurrently, as long as the remote operation apparatuses do not conflict with each other in operating the operation target apparatus 200.

[Data Transmitting/Receiving Process (Regarding Transmitted/Received Data)]

As described above, according to the remote operation system 100, in a case where the remote operation apparatus 300 and the operation target apparatus 200 have not been paired yet, a pairing process is carried out before the remote operation apparatus 300 and the operation target apparatus 200 are connected to each other via Bluetooth communication, whereas in a case where the remote operation apparatus 300 and the operation target apparatus 200 have already been paired, a reconnection process is carried out so that the remote operation apparatus 300 and the operation target apparatus 200 are connected to each other via Bluetooth communication. Then, the data transmitting/receiving process is carried out while the remote operation apparatus 300 and the operation target apparatus 200 are being connected via Bluetooth communication. The following description deals with the data transmitting/receiving process.

In the data transmitting/receiving process, the remote operation apparatus 300 transmits a “command” or a “data transmission request” so as to operate the operation target apparatus 200. The “command” and the “data transmission request” are described below.

Each of command and data transmission request is an instruction which is generated by carrying out a predetermined input operation with respect to the operating section 308 of the remote operation apparatus 300 and is then supplied to the operation target apparatus 200 via the operating-side second communication section 302. In the present embodiment, this instruction is classified into the “command” and the “data transmission request” according to the type of a data structure.

Specifically, a command has a data structure including a command name, a parameter indicative of a content of the command, a reply flag indicating whether a reply from an apparatus (in this case, the operation target apparatus 200) which has received the command is required or not, an address of a transmission source of the command, and an address of a transmission destination of the command. For example, the command can be data shown in Table 6 below.

TABLE 6

| Type | Data | Meaning |
|---|---|---|
| Command Name | COMMAND_CH_CHANGE | Channel Changing |
| | | Command |
| Parameter | 6 | Channel 6 |
| Reply Flag | 1 | Reply is required (0 |
| | | indicates reply is |
| | | not required) |
| Source Address | 00:11:22:33:66:AA | |
| Destination | 00:11:22:33:44:AA | |
| Address | | |

Table 6 shows an example of a command for changing an output channel of the operation target apparatus 200. The operation target apparatus 200 can judge, with reference to the command name, what kind of command has been sent, and can judge, with reference to the parameter, what kind of processing should be carried out. Moreover, the operation target apparatus can determine, based on the source address, which apparatus has transmitted the command. Specifically, the operation target apparatus 200 which has received the command shown in Table 6 can determine that the remote operation apparatus 300 has transmitted an instruction to change the channel to channel 6.

Instructions for changing audio output and/or image output of the operation target apparatus 200 such as the one for changing the channel are classified into the “command”. Since the “command” is an instruction to change audio output and/or image output of the operation target apparatus 200, conflicts among processes may occur in a case where instructions given by a plurality of remote operation apparatuses are all activated. On this account, the “command” is an instruction on which the remote controller restriction is set.

Further, in the present embodiment, it is assumed that a special command called “end command” is used in addition to commands for controlling general operations, such as a command for changing the channel and a command for changing sound volume. The end command is a command for causing the remote operation apparatus 300 to finish its operation of the operation target apparatus 200. By transmitting the end command, the remote operation apparatus 300 terminates a function (remote controller application) for operating the operation target apparatus 200 and returns to a normal mobile phone. As for a data structure of the end command, a command name thereof is “END” for example, a parameter thereof contains no data, and a reply flag thereof is set to “0”.

Note that a reply flag is data indicating whether or not it is necessary to notify the remote operation apparatus 300 of whether or not a command to which the reply flag is attached can be executed in the operation target apparatus 200. That is, in a case where a reply flag of a received command indicates that a reply is needed, the operation target apparatus 200 judges whether the command can be executed or not. In a case where the operation target apparatus 200 can execute the command, a reply indicating that the command can be executed is returned to the remote operation apparatus 300. Meanwhile, in a case where the command cannot be executed due to the communication restriction process, a reply indicating that the command cannot be executed is returned to the remote operation apparatus 300. Note that whether the command can be executed or not is determined depending on the remote controller restriction setting.

A reply can be data shown in Table 7 below. Table 7 shows an example of data of a reply that is transmitted from the operation target apparatus 200 to the remote operation apparatus 300 in a case where the operation target apparatus 200 receives a command whose reply flag indicates that a reply is needed. Specifically, in the example of FIG. 7, in a case where the operation target apparatus 200 can execute the command, data “RES_ACCEPT” is supplied from the operation target apparatus 200 to the remote operation apparatus 300, whereas in a case where the operation target apparatus 200 cannot execute the command, data “RES_DENY” is supplied from the operation target apparatus 200 to the remote operation apparatus 300.

TABLE 7

| | | | Destination | |
|---|---|---|---|---|
| Type | Data | Source Address | Address | Meaning |
| Accept | RES_ACCEPT | 00:11:22:33:44:AA | 00:11:22:33:66:AA | Command |
| Response | | | | was |
| | | | | successfully |
| | | | | executed |
| Deny | RES_DENY | 00:11:22:33:44:AA | 00:11:22:33:66:AA | Command |
| Response | | | | was denied |
| | | | | (failed) |

On the other hand, the data transmission request is an instruction to demand a transmission source of the request to transmit some kind of data. The request has a data structure including a request name and a data name. For example, the data transmission request can be data shown in Table 8 below. Table 8 shows an example of the data transmission request.

TABLE 8

| Type | Data | Meaning |
|---|---|---|
| Request Name | REQ_DATA | Data Transmission |
| | | Request |
| Data Name | NOW_PROGRAM | Current Program |
| | | Information |
| Source Address | 00:11:22:33:66:AA | |
| Destination Address | 00:11:22:33:44:AA | |

According to the data transmission request shown in Table 8, the request name “REQ_DATA” shows that the data transmission request is a request for data transmission and the data name “NOW_PROGRAM” shows that current program information is requested. Moreover, a transmission source of the data transmission request can be specified based on the source address. Note that the program information is information such as a program name of a TV show and names of performers in the TV show. In addition to the transmission request for current program information, a transmission request for information concerning a program shown at a time or on a channel designated by a user and a transmission request for a TV program listing are classified into the data transmission request.

The operation target apparatus 200 which has received the data transmission request as shown in Table 8 returns data as shown in Table 9, for example. Table 9 shows an example of current program information transmitted by the operation target apparatus 200. The program information is thus transmitted to the remote operation apparatus 300. This allows a user of the remote operation apparatus 300 to see the program information by causing the display section 307 to display the program information.

TABLE 9

| Type | Data | Meaning |
|---|---|---|
| Response Name | RES_DATA | Reply to data |
| | | transmission request |
| Data Name | NOW_PROGRAM | Current program |
| | | information |
| Data Size | 1024 | Data size (Bytes) |
| Data Body | . . . | Data entity (binary) |
| Source Address | 00:11:22:33:44:AA | |
| Destination Address | 00:11:22:33:66:AA | |

The “data transmission request” is an instruction which does not change audio output and image output of the operation target apparatus 200. As such, even in a case where a plurality of remote operation apparatuses send “data transmission requests” at the same time, the operation target apparatus 200 is only required to sequentially supply data to the transmission sources of the “data transmission requests”. As a result, there is no conflict among processes carried out in the operation target apparatus 200. On this account, in the operation target apparatus 200, the remote controller restriction process is not carried out with respect to the “data transmission request”.

[Data Transmitting/Receiving Process (Remote Operation Apparatus 300 Side)]

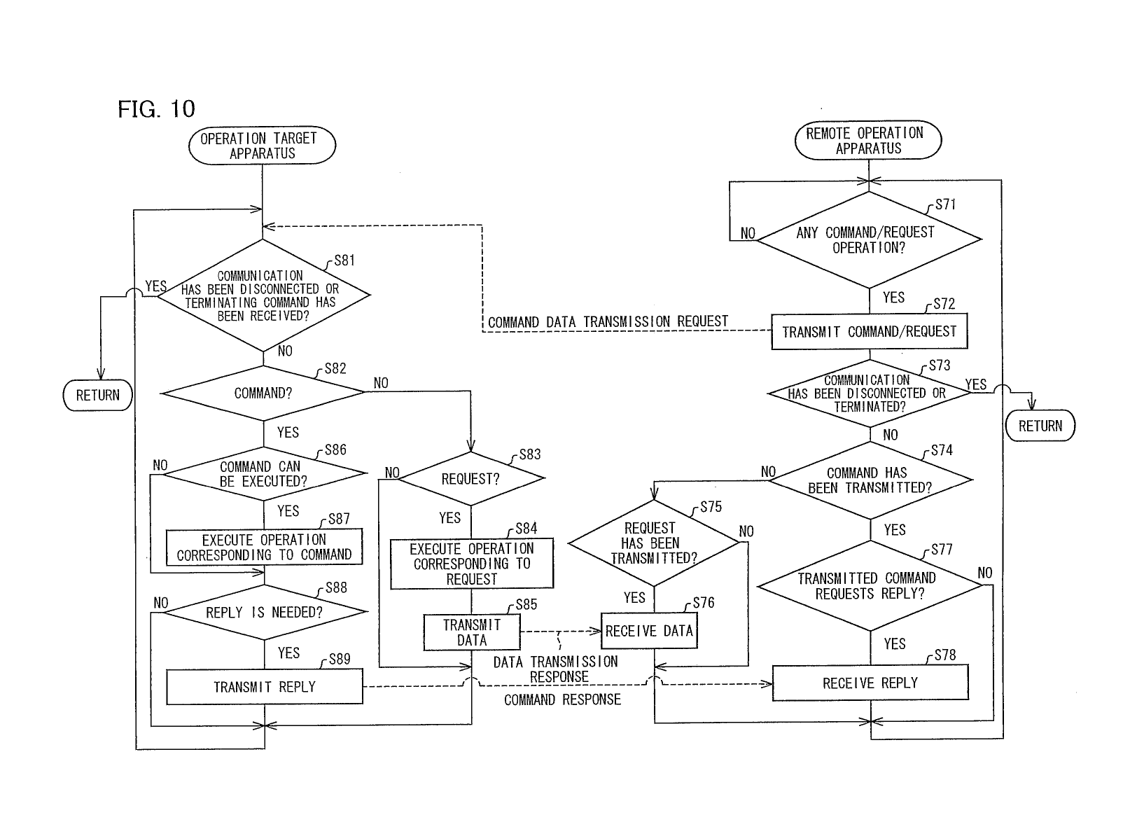

Next, with reference to FIG. 10, the following describes a flow of the data transmitting/receiving process carried out in S9 and S27 of the flowchart of FIG. 7. FIG. 10 is a flow chart showing an example of the data transmitting/receiving process. First, a flow of the data transmitting/receiving process carried out in S9 of FIG. 7 by the remote operation apparatus 300 is discussed, and then a flow of the data transmitting/receiving process carried out in S27 of FIG. 7 by the operation target apparatus 200 is discussed.

After a Bluetooth communication connection is established between the remote operation apparatus 300 and the operation target apparatus 200, the operating-side communication control section 12 awaits a command operation or a request operation (S71). In a case where a command operation or a request operation is carried out (YES in S71), the operating-side communication control section 12 instructs the operating-side second communication section 302 to transmit, to the operation target apparatus 200, a command corresponding to the command operation or a request corresponding to the request operation (S72).

Here, the operating-side communication control section 12 confirms whether or not the Bluetooth communication between the remote operation apparatus 300 and the operation target apparatus 200 has been disconnected or whether or not a terminating operation has been performed in the remote operation apparatus 300 (S73). In a case where it is determined that the Bluetooth communication has been disconnected or it is determined that the terminating operation has been performed in the remote operation apparatus 300 (YES in S73), the operating-side communication control section 12 terminates the data transmitting/receiving process. In this case, the process proceeds from S9 to S10 in the flow chart of FIG. 7. Then, in a case where the Bluetooth communication has been disconnected, the process returns to S2, whereas in a case where the terminating operation has been performed, the remote controller application is terminated.

Meanwhile, in a case where the Bluetooth communication has not been disconnected and where the terminating operation has not been performed in the remote operation apparatus 300 (NO in S73), the operating-side communication control section 12 confirms whether or not the command has been transmitted in S72 (S74). In a case where the command has not been transmitted in S72 (NO in S74), the operating-side communication control section 12 confirms whether or not the request has been transmitted in S72 (S75).

In a case where it cannot be confirmed that the request has been transmitted in S72 (NO in S75), the process returns to S71 where the operating-side communication control section 12 awaits a command operation or a request operation. Meanwhile, in a case where it is confirmed that the request has been transmitted in S72 (YES in S75), the operating-side communication control section 12 receives data requested in S72 (S76). In a case where the data thus received is data (e.g., program information) that needs to be presented to a user, the operating-side communication control section 12 may cause the display section 307 to display the data thus received so that the user can confirm the requested data immediately. Alternatively, the user may determine whether the data thus received is displayed or not. After the process in S76 is finished, the process returns to S71 where the operating-side communication control section 12 awaits a command operation or a request operation.

In a case where it is confirmed that the command has been transmitted in S74, the operating-side communication control section 12 confirms whether the command thus transmitted requests a reply or not (S77). In the present embodiment, it is assumed that a reply flag of a command which requests a reply is set to 1 as shown in Table 6. Accordingly, in case where a reply flag of the command thus transmitted is set to 1, the operating-side communication control section 12 judges that the command requests a reply, whereas in a case where the reply flag is set to 0, the operating-side communication control section 12 judges that the command does not request a reply.

In a case where the command thus transmitted requests a reply (YES in S77), the operation target apparatus 200 which has received the command returns a reply, and the operating-side communication control section 12 receives this reply (S78).

In a case where the reply thus received indicates that execution of the command has succeeded, the operating-side communication control section 12 does not need to notify a user of the success. However, in a case where the reply thus received indicates that execution of the command has failed, it is preferable that the operating-side communication control section 12 notifies a user of the failure, for example, by causing the display section 307 to display a message indicating the failure. This allows the user to recognize that the execution of the command has failed and to take measures (e.g., perform an input operation again) according to need.

Meanwhile, in a case where the command thus transmitted does not request a reply (NO in S77), the process returns to S71 where the operating-side communication control section 12 awaits a command operation or a request operation.

[Data Transmitting/Receiving Process (Operation Target Apparatus 200 Side)]

Next, with reference to FIG. 10, the following deals with a flow of the data transmitting/receiving process that is carried out in S27 of FIG. 7 by the operation target apparatus 200. After Bluetooth communication is established between the remote operation apparatus 300 and the operation target apparatus 200, the operated-side communication control section 3 awaits a signal supplied from the remote operation apparatus 300. Then, the operated-side communication control section 3 confirms whether or not the Bluetooth communication has been disconnected and whether or not the signal supplied from the remote operation apparatus 300 is an end command or not (S81).

In a case where the Bluetooth communication has been disconnected or in a case where the end command has been received (YES in S81), the operated-side communication control section 3 terminates the data transmitting/receiving process. In this case, the process returns from S27 to S21 in the flowchart of FIG. 7. Meanwhile, in a case where the Bluetooth communication has not been disconnected and where the end command has not been received (NO in S81), the operated-side communication control section 3 confirms whether the signal supplied from the remote operation apparatus 300 is a command or not (S82).

In a case where reception of a command cannot be confirmed (NO in S82), the operated-side communication control section 3 then confirms whether the signal supplied from the remote operation apparatus 300 is a request or not (S83). In a case where reception of a request is confirmed (YES in S83), the operated-side communication control section 3 executes an operation corresponding to the request thus received (S84), and then instructs the operated-side second communication section 209 to supply requested data to the remote operation apparatus 300 (S85). Then, the process returns to S81 where the operated-side communication control section 3 which has given the instruction to supply the requested data awaits a signal from the remote operation apparatus 300.

Meanwhile, in a case where reception of a command is confirmed in S82 (YES in S82), the operated-side communication control section 3 confirms whether the command thus received can be executed or not (S86). Specifically, the operated-side communication control section 3 specifies a transmission source terminal of the command on the basis of a source address attached to the command thus received.

Then, the operated-side communication control section 3 confirms whether or not the transmission source terminal of the command is given the highest priority among apparatuses which are registered in the operated-side connection destination management section 2 and which are currently Bluetooth-connected with the operation target apparatus 200. In a case where the transmission source terminal of the command is given the highest priority, it is determined that the command can be executed, whereas in a case where another apparatus is given the highest priority, it is determined that the command cannot be executed.

In a case where the command can be executed (YES in S86), the operated-side communication control section 3 executes an operation corresponding to the command thus received (S87). In a case where it is determined in S86 that the command cannot be executed or after the command is executed in S87, the operated-side communication control section 3 confirms whether or not a reply to the command thus received is required or not (S88).

In a case where a reply is required (YES in S88), the operated-side communication control section 3 instructs the operated-side second communication section 209 to transmit a reply to the remote operation apparatus 300 (S89). Then, the process returns to S81 where the operated-side communication control section 3 which has given the instruction to transmit the reply awaits a signal from the remote operation apparatus 300. Also in a case where no reply is required (NO in S88), the process returns to S81 where the operated-side communication control section 3 awaits a signal from the remote operation apparatus 300.

In the remote operation system 100, data is transmitted and received in this manner. Since data is transmitted and received via Bluetooth communication, a larger amount of data can be more speedily transmitted and received, as compared to infrared communication. Moreover, since Bluetooth communication is nondirectional communication, communication connection can be maintained even in a case where the remote operation apparatus 300 is moved during data transmission and even in a case where there is an obstacle between the remote operation apparatus 300 and the operation target apparatus 200.

Note that the data transmitting/receiving process described above is an exemplary data transmitting/receiving process. Therefore, data transmission/reception performed after the pairing process or the reconnection process can be performed in any manner. Moreover, data transmitted/received after the pairing process or the reconnection process can be any data, and therefore is not limited to the examples shown in Tables 4 to 9.

### Embodiment 2

As described in Embodiment 1, according to the pairing method of the present invention, a pairing process can be executed without the need for a user to carry out any special operation. With the use of such a method for easily carrying out a pairing process, it is also possible that a pairing process is carried out every time Bluetooth communication connection is attempted.

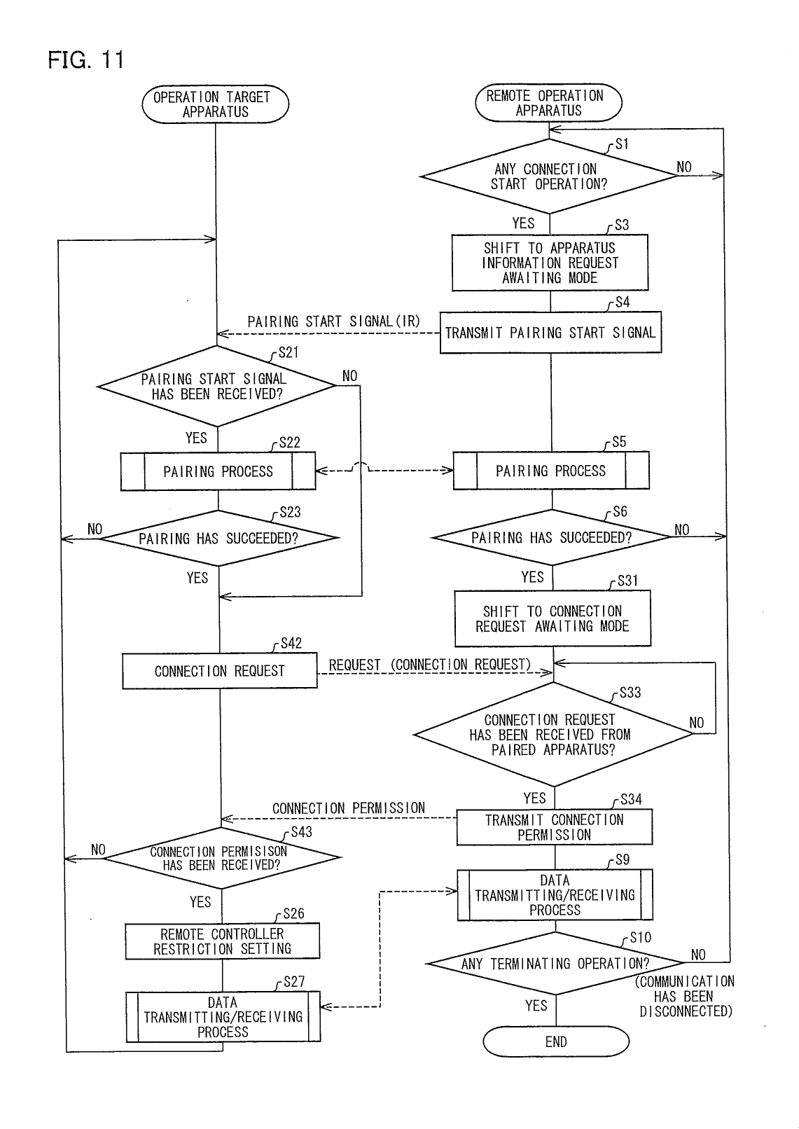

With reference to FIG. 11, the present embodiment deals with an example in which a pairing process is carried out every time Bluetooth communication is attempted. In a case where a pairing process is carried out every time Bluetooth communication is attempted, a PIN code can be changed without causing any problem. This improves a security of the remote operation system 100. Note that arrangements and processes which are identical to those of the Embodiment 1 are given identical reference numerals, and are not explained repeatedly.

FIG. 11 is a flowchart illustrating an example of processes carried out in the remote operation system 100 in which a pairing process is carried out every time Bluetooth communication is attempted. When a remote controller application is activated in a remote operation apparatus 300, a pairing start section 17 awaits a connection start operation (S1). In a case where the connection start operation is confirmed (YES in S1), the pairing start section 17 instructs an operating-side pairing executing section 14 to shift to an apparatus information request awaiting mode (S3). Further, the pairing start section 17 instructs an operating-side first communication section 301 to transmit a pairing start signal (S4).

Then, the operating-side pairing executing section 14 pairs the remote operation apparatus 300 with an operation target apparatus 200 which has received the pairing start signal (S5) so that the remote operation apparatus 300 and the operation target apparatus 200 register each other's addresses for Bluetooth communication.

In a case where the pairing process in S5 has succeeded (YES in S6), an operating-side communication control section 12 shifts to a connection request awaiting mode (S31) and awaits a connection request from an apparatus with which the remote operation apparatus 300 has been paired (S33). In a case where the pairing process in S5 has failed (NO in S6), the process returns to S1.

In a case where it is confirmed that the connection request has been received and that a transmission source of the connection request is an apparatus with which the remote operation apparatus 300 has been paired (YES in 33), the operating-side communication control section 12 instructs an operating-side second communication section 302 to transmit a connection permission to the operation target apparatus 200 (S34). When this connection permission is received by the operation target apparatus 200, Bluetooth communication connection is established between the remote operation apparatus 300 and the operation target apparatus 200.

After the Bluetooth communication connection is established, a data transmitting/receiving process is carried out (S9). In a case where the data transmitting/receiving process is terminated due to disconnection of the communication (NO in S10), the process returns to S1, whereas in a case where the data transmitting/receiving process is terminated by a terminating operation (YES in S10), the remote controller application is terminated.

Meanwhile, an operated-side pairing executing section 1 of the operation target apparatus 200 awaits a pairing start signal (S21). In a case where reception of the pairing start signal is confirmed (YES in S21), the operated-side pairing executing section 1 executes a pairing process (S22).

In a case where the pairing process has failed (NO in S23), the process returns to S21, whereas in a case where the pairing process has succeeded (YES in S23), an operated-side communication control section 3 instructs an operating-side second communication section 302 to transmit a connection request to the remote operation apparatus 300. After giving the instruction to transmit the connection request, the operated-side communication control section 3 awaits a connection permission (S43).

In a case where reception of a connection permission cannot be confirmed within a predetermined period of time after the transmission of the connection request (NO in S43), the process returns to S21. Meanwhile, in a case where reception of the connection permission can be confirmed within a predetermined period of time after the transmission of the connection request (YES in S43), the operated-side communication control section 3 carries out a remote controller restriction setting process (S26), and then carries out a data transmitting/receiving process (S27).

As described above, in the remote operation system 100 of the present embodiment, a pairing process is carried out every time the remote operation apparatus 300 and the operation target apparatus 200 are connected via Bluetooth communication. Although, according to this method, a pairing process is carried out every time Bluetooth communication is attempted, a user is only required to carry out a connection start operation in order to establish Bluetooth communication. Therefore, a user of the remote operation apparatus 300 can operate the operation target apparatus 200 in a similar manner to a conventional general infrared remote controller without being aware of pairing.

As described with reference to the flow chart of FIG. 9, PIN code verification is carried out in the pairing process. Accordingly, in the remote operation system 100 of the present embodiment, PIN code verification is carried out every time the remote operation apparatus 300 and the operation target apparatus 200 are connected via Bluetooth communication. As such, a PIN code can be changed without causing any problem. This allows an improvement in security of the system.

In the remote operation system 100 of the present embodiment, a pairing process is carried out every time Bluetooth communication is attempted. This eliminates the need for the reconnection process carried out in S11 of FIG. 7, thereby eliminating the need for the step of transmitting a connection start signal, the step of transmitting a remote controller ID, and the step of transmitting and storing the remote controller ID.

The above description has dealt with an example in which the operation target apparatus 200 transmits, to the remote operation apparatus 300, an apparatus information request along with a communication address of the operation target apparatus 200, and the remote operation apparatus 300 which has received the apparatus information request transmits apparatus information (communication address) of the remote operation apparatus 300 to the operation target apparatus 200. However, another arrangement is possible in which the remote operation apparatus 300 transmits, to the operation target apparatus 200, an apparatus information request along with the communication address of the remote operation apparatus 300.

In this case, the remote operation apparatus 300 does not carry out the process in S3 of FIG. 11, and the operation target apparatus 200 which has received a pairing start signal shifts to an apparatus information request awaiting mode. Then, the remote operation apparatus 300 transmits, to the operation target apparatus which is in the apparatus information request awaiting mode, an apparatus information request along with a communication address of the remote operation apparatus 300. Thus, the remote operation apparatus 300 acquires apparatus information of the operation target apparatus 200. Even with this arrangement, the remote operation apparatus 300 can be paired with the operation target apparatus 200.

### Embodiment 3

According to the arrangements of the above Embodiments, when a pairing process is carried out, the operation target apparatus 200 transmits a PIN code request to the remote operation apparatus 300, and in response to the PIN code request, the remote operation apparatus 300 transmits a PIN code. Then, the operation target apparatus 200 carries out PIN code verification so as not to be paired with an apparatus that is not intended by a user.

In the present embodiment, an operation target apparatus 200 which has received a pairing start signal causes a display section 204 to display a passkey. Then, a user of a remote operation apparatus 300 enters the passkey thus displayed. Thus, the passkey is verified.

Accordingly, the operation target apparatus 200 can be paired only with an apparatus whose user is able to see the display section 204. Moreover, the operation target apparatus 200 changes or cancels the passkey displayed on the display section 204 at a predetermined timing, thereby preventing a third party who has acquired the passkey from carrying out pairing with the operation target apparatus 200.

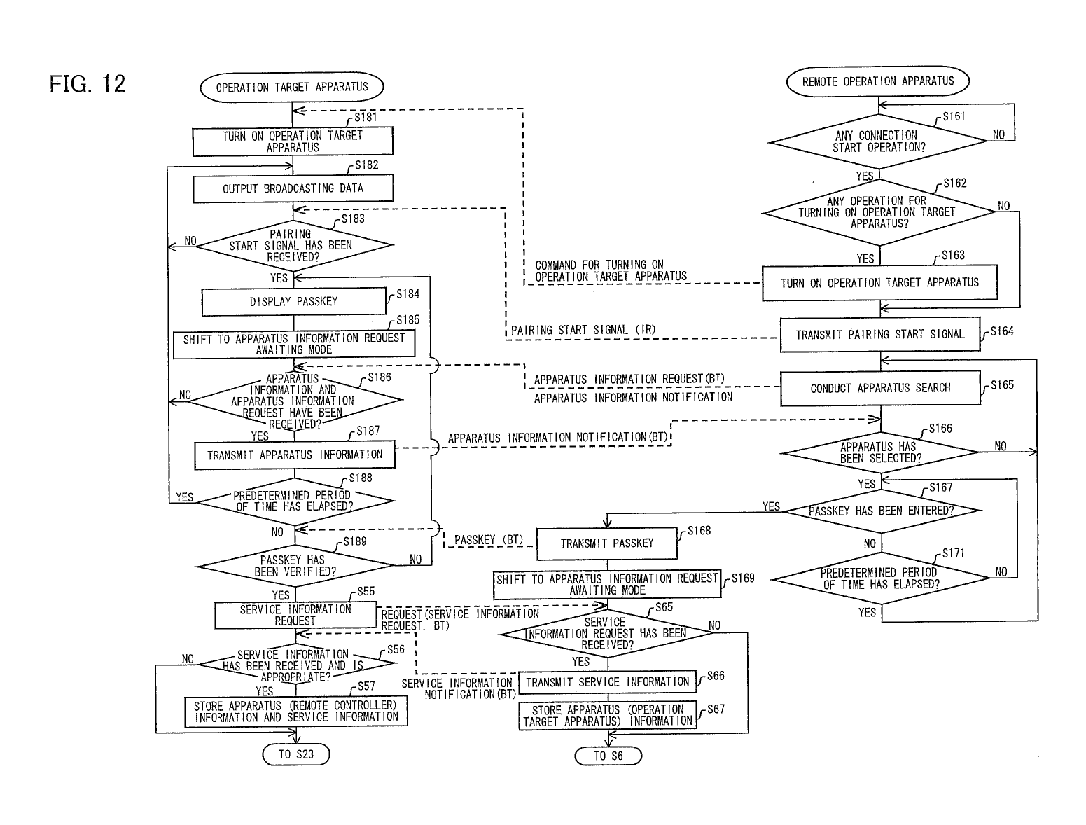

With reference to FIGS. 12 through 14, the following description deals with an example in which verification is carried out with the use of a passkey displayed on the operation target apparatus 200. Note that arrangements of the operation target apparatus 200 and the remote operation apparatus 300 are similar to those of the above Embodiments (see FIGS. 1 and 2).

Note, however, that the arrangement of the operation target apparatus 200 is different from that of the above Embodiments, for example, in that an operated-side pairing executing section 1 has a function as password output means for generating and outputting a passkey and a function as password collating means for judging whether or not a passkey received from the remote operation apparatus 300 matches the passkey thus generated and outputted.

Moreover, the arrangement of the remote operation apparatus 300 is different from that of the above Embodiments, for example, in that the operating-side pairing executing section 14 has a function of accepting a user's entry of a passkey and transmitting the passkey entered by the user to the operation target apparatus 200.

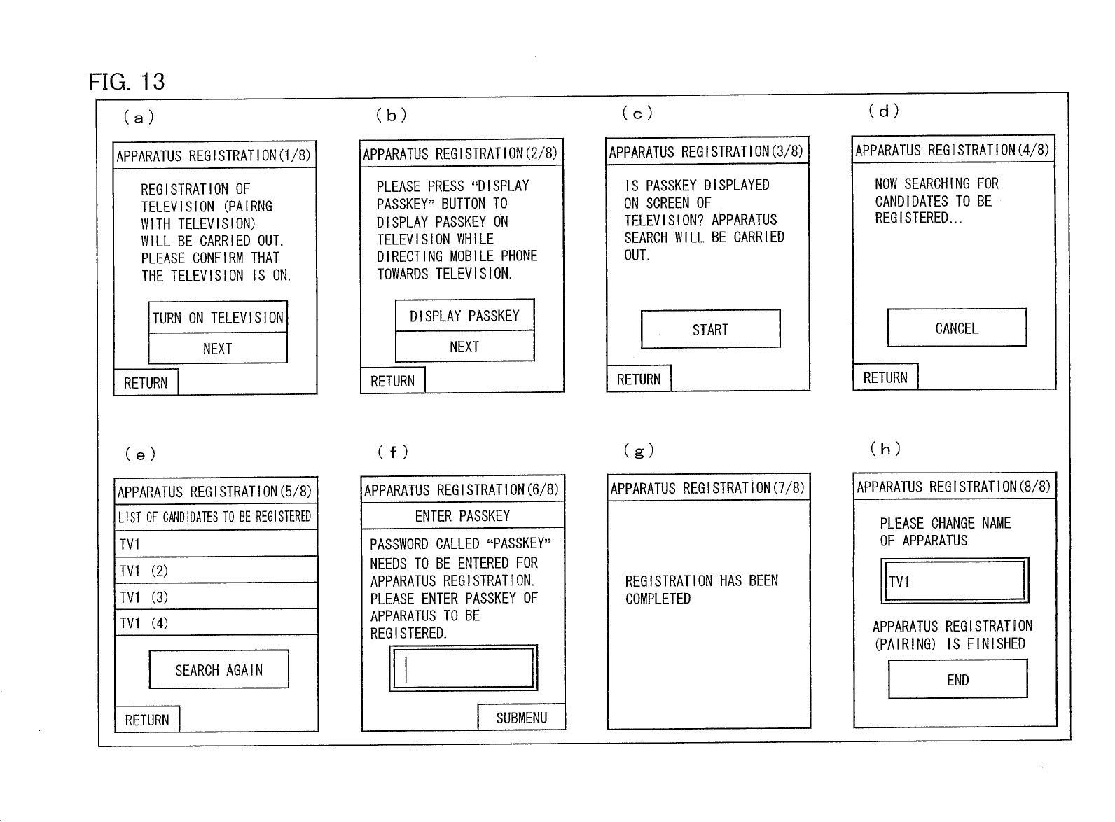

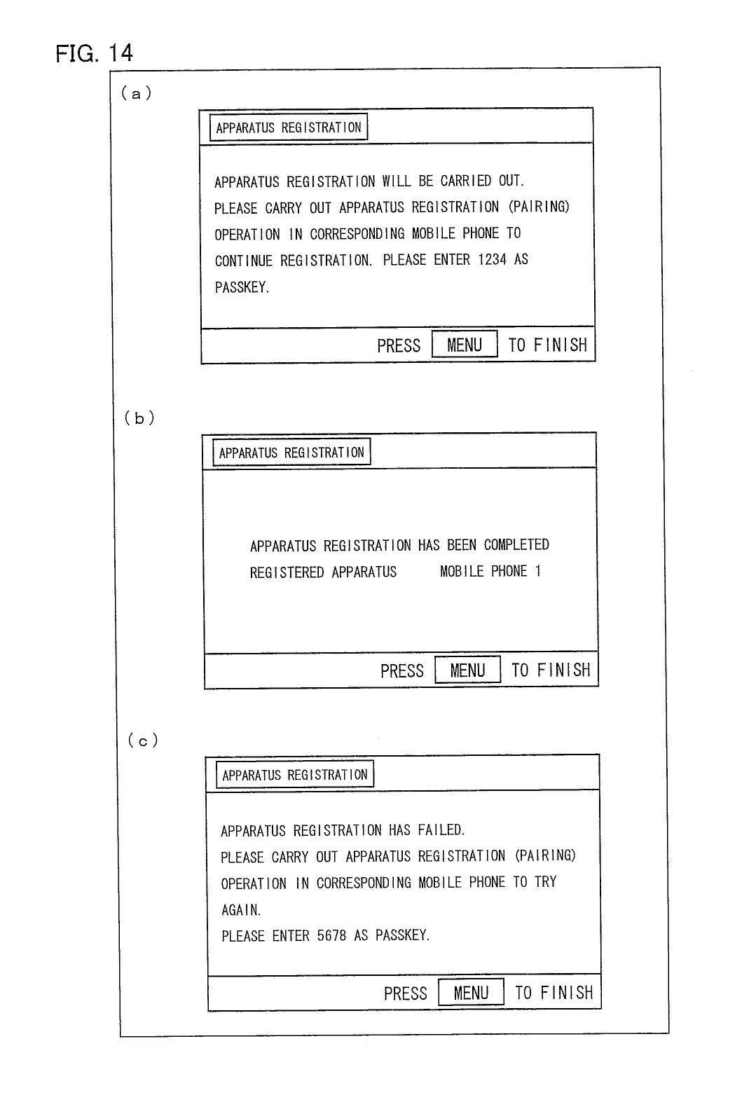

FIG. 12 is a flowchart illustrating an example of processes carried out by the operation target apparatus 200 and the remote operation apparatus 300 in the present embodiment. FIG. 13 illustrates an example of screens that are displayed on a display section 307 of the remote operation apparatus 300 during the processes of FIG. 12. FIG. 14 illustrates an example of screens that are displayed on the display section 204 of the operation target apparatus 200 during the processes of FIG. 12.

[Process Flow (Remote Operation Apparatus 300 Side)]

First, a pairing start section 17 confirms whether or not there is a connection start operation (S161). As described above, the connection start operation is an input operation for starting a remote operation of the operation target apparatus 200. In a case where the connection start operation is confirmed (YES in S161), the pairing start section 17 awaits an input operation for turning on the operation target apparatus 200 (S162).

During the process in S162, the pairing start section 17 causes the display section 307 to display an image as illustrated in (a) of FIG. 13. The “APPARATUS REGISTRATION (1/8)” displayed at the top of the screen of (a) of FIG. 13 allows a user to recognize that the screen is a screen for apparatus registration and that the first process out of eight processes is being carried out. Note that the apparatus registration indicates a pairing process.

Further, as illustrated in (a) of FIG. 13, on an upper portion of a central area of the screen, there is a message notifying a user of a start of the apparatus registration and prompting the user to confirm whether or not the operation target apparatus 200 to be registered is on. This is because a pairing process cannot be carried out in a case where the operation target apparatus 200 is off.

Furthermore, as illustrated in (a) of FIG. 13, on a lower portion of the central area of the screen, there are a selection item for turning on a television (the operation target apparatus 200) and a selection item for advancing to a next step of the apparatus registration.

In a case where an input operation for selecting the selection item for turning on the operation target apparatus 200 is detected (YES in S162), the pairing start section 17 generates a command for turning on the operation target apparatus 200, and then transmits the command via an operating-side first communication section 301 (S164). After the process in S163 is finished, a process in S164 is carried out.

Meanwhile, in a case where an input operation for selecting the selection item for advancing to the next step is detected, the pairing start section 17 judges that the input operation for turning on the operation target apparatus 200 has not been carried out (NO in S162). In this case, the process in S163 is omitted, and the process proceeds to S164.

Further, as illustrated in (a) of FIG. 13, on a bottom portion of the screen, there is a selection item “RETURN”. In a case where an input operation selecting the selection item “RETURN” is detected, the process returns to S161 where the pairing start section 17 awaits a connection start operation. Note that, for simplification of description, this process is not shown in FIG. 12.

In S164, the pairing start section 17 transmits, upon detection of a predetermined input operation from the user, a pairing start signal via the operating-side first communication section 301. The pairing start section 17 may prompt the input operation from the user by causing the display section 307 to display an image as illustrated in (b) of FIG. 13, for example.

The “APPARATUS REGISTRATION (2/8)” displayed at the top of the screen of (b) of FIG. 13 allows the user to recognize that the screen is a screen for apparatus registration and that the second process out of eight processes is being carried out.

Further, as illustrated in (b) of FIG. 13, on an upper portion of a central area of the screen, there is a message for notifying the user that a passkey (corresponding to “PIN code” of the above embodiments) is displayed on the television (the operation target apparatus 200) and for prompting the user to push a “DISPLAY PASSKEY” button while directing the remote operation apparatus 300 towards the operation target apparatus 200.

Furthermore, as illustrated in (b) of FIG. 13, on a lower portion of the central area of the screen, the selection item “DISPLAY PASSKEY”, i.e., the “DISPLAY PASSKEY” button and a selection item for advancing to a next step of the apparatus registration are displayed. Moreover, on a bottom portion of the screen, there is a selection item “RETURN”.

In a case where an input operation selecting the “DISPLAY PASSKEY” button is detected, the pairing start section 17 transmits a pairing start signal. Then, the process proceeds to S165. Meanwhile, in a case where an input operation selecting the selection item for advancing to the next step is detected, the pairing start section 17 does not transmit the pairing start signal. Then, the process proceeds to S165.

As illustrated in (b) of FIG. 13, the selection item “RETURN” is displayed on the bottom portion of the screen. In a case where an input operation selecting the selection item “RETURN” is detected, the process returns to S162 where the pairing start section 17 causes the display section 307 to display the image of (a) of FIG. 13, and awaits an input operation for turning on the operation target apparatus 200. Note that, for simplification of description, this process is not shown in FIG. 12.

Subsequently, the pairing start section 17 instructs an operating-side pairing executing section 14 to conduct an apparatus search. The apparatus search is a process of searching for apparatuses that are capable of communicating with the operating-side second communication section 302 via Bluetooth communication. As a result of the apparatus search, Bluetooth communication addresses and model names (apparatus names) of the apparatuses that are capable of communicating with the operating-side second communication section 302 via Bluetooth communication are acquired.

That is, in the Embodiments 1 and 2, the remote operation apparatus 300 acquires an address of the operation target apparatus 200 from an apparatus information request including the address of the operation target apparatus 200 (see S51 and S61 of FIG. 9 and Table 5). On the other hand, in the present embodiment, the remote operation apparatus 300 transmits, in the apparatus search, an apparatus information request including an address (apparatus information) of the remote operation apparatus 300. Then, the remote operation apparatus 300 acquires an address of the operation target apparatus 200 which address is transmitted by the operation target apparatus 200 in response to the apparatus information request.

Needless to say, also in the present embodiment, the communication address of the operation target apparatus 200 can be acquired only by using an apparatus information request without conducting the apparatus search, as in the above embodiments. Moreover, in the above embodiments, the communication address of the operation target apparatus 200 can be acquired by conducting the apparatus search etc.

The operating-side pairing executing section 14 may conduct the apparatus search immediately after receipt of the instruction from the pairing start section 17 or may cause the display section 307 to display an image as illustrated in (c) of FIG. 13 so as to inquire of the user whether the apparatus search should be conducted or not.

The “APPARATUS REGISTRATION (3/8)” displayed at the top of the screen of (c) of FIG. 13 allows the user to recognize that the screen is a screen for apparatus registration and that the third process out of eight processes is being carried out.

Further, as illustrated in (c) of FIG. 13, on an upper portion of a central area of the screen, there is a message for prompting the user to confirm whether the passkey is displayed on the television (the operation target apparatus 200) or not and for notifying the user that the apparatus search will be carried out. Furthermore, as illustrated in (c) of FIG. 13, a selection item “START” is displayed on a lower portion of the central area of the screen, and a selection item “RETURN” is displayed on the bottom portion of the screen.

In a case where the screen as illustrated in (c) of FIG. 13 is displayed so that an input operation from the user can be accepted, the operating-side pairing executing section 14 conducts an apparatus search upon detection of an input operation for selecting the selection item “START” (S165). In a case where the operating-side pairing executing section 14 detects an input operation for selecting the selection item “RETURN”, the process returns to S164 where the screen of (b) of FIG. 13 is displayed again. Note that, for simplification of description, this process is not shown in FIG. 12.

Since it takes some time to complete the apparatus search, it is preferable that the operating-side pairing executing section 14 causes the display section 307 to display a screen as illustrated in (d) of FIG. 13 during the apparatus search so that the user can stop the apparatus search.

The “APPARATUS REGISTRATION (4/8)” displayed at the top of the screen of (d) of FIG. 13 allows the user to recognize that the screen is a screen for apparatus registration and that the fourth process out of eight processes is being carried out.

Further, as illustrated in (d) of FIG. 13, on an upper portion of a central area of the screen, there is a message for notifying the user that an apparatus to be registered (the operation target apparatus 200) is being searched. Furthermore, as illustrated in (d) of FIG. 13, a selection item “CANCEL” is displayed on a lower portion of the central area of the screen, and a selection item “RETURN” is displayed on the bottom portion of the screen.

In a case where the screen as illustrated in (d) of FIG. 13 is displayed so that an input operation from the user can be accepted, the operating-side pairing executing section 14 stops the apparatus search upon detection of an input operation for selecting the selection item “CANCEL”. Then, the process proceeds to S166. Meanwhile, upon detection of an input operation for selecting the selection item “RETURN”, the process returns to S165 where the operating-side pairing executing section 14 causes the display section 307 to display the screen of (c) of FIG. 13 for prompting the user to conduct an apparatus search again. Note that, for simplification of description, this process is not shown in FIG. 12.

In a case where the apparatus search is completed or stopped, the operating-side pairing executing section 14 prompts the user to select a partner apparatus to be paired with the remote operation apparatus 300 from among apparatuses detected as a result of the apparatus search (S166). The operating-side pairing executing section 14 can prompt the user to select a partner apparatus, for example, by causing the display section 307 to display a screen as illustrated in (e) of FIG. 13.

The “APPARATUS REGISTRATION (5/8)” displayed at the top of the screen of (e) of FIG. 13 allows the user to recognize that the screen is a screen for apparatus registration and that the fifth process out of eight processes is being carried out.

Further, as illustrated in (e) of FIG. 13, on an upper portion of a central area of the screen, a list of candidates for the apparatus to be registered is shown. Furthermore, as illustrated in (e) of FIG. 13, a selection item “SEARCH AGAIN” is displayed on a lower portion of the central area of the screen, and a selection item “RETURN” is displayed on a bottom portion of the screen.

In a case where the screen as illustrated in (e) of FIG. 13 is displayed so that an input operation from the user can be accepted, the operating-side pairing executing section 14 judges, upon detection of an input operation for selecting one of the apparatuses in the list, that the apparatus thus selected is a partner apparatus to be paired with the remote operation apparatus 300 (YES in S166), and then the process proceeds to S167.

Meanwhile, upon detection of an input operation for selecting the selection item “RETURN”, the operating-side pairing executing section 14 judges that selection of an apparatus has not been carried out (NO in S166), and then the process returns to S165 where the screen of (c) of FIG. 13 is displayed again. Meanwhile, upon detection of an input operation for selecting the selection item “SEARCH AGAIN”, the operating-side pairing executing section 14 conducts an apparatus search again (S165). That is, the screen of (d) of FIG. 13 is displayed again. Note that, for simplification of description, this process is not shown in FIG. 12.

In a case where a partner apparatus to be paired with the remote operation apparatus 300 has been selected, the operating-side pairing executing section 14 prompts the user to enter the passkey (S167). The operating-side pairing executing section 14 can prompt the user to enter the passkey, for example, by causing the display section 307 to display a screen as illustrated in (f) of FIG. 13.

The “APPARATUS REGISTRATION (6/8)” displayed at the top of the screen of (f) of FIG. 13 allows the user to recognize that the screen is a screen for apparatus registration and that the sixth process out of eight processes is being carried out.

Further, as illustrated in (f) of FIG. 13, on an upper portion of a central area of the screen, there is a message for notifying the user that entry of a passkey is necessary for the apparatus registration and for prompting the user to enter the passkey. Furthermore, as illustrated in (f) of FIG. 13, a text box in which the passkey is entered is displayed on a lower portion of the central area of the screen, and a selection item “SUBMENU” is displayed on a bottom portion of the screen.

In a case where the screen as illustrated in (f) of FIG. 13 is displayed so that an input operation from the user can be accepted, the operating-side pairing executing section 14 judges, upon detection of entry of the passkey in the text box and an operation for deciding the passkey thus entered, that the passkey is entered (YES in S167), and then the process proceeds to S168.

In a case where selection of the selection item “SUBMENU” is detected, the operating-side pairing executing section 14 causes the display section 307 to display a submenu for passkey entry. The submenu includes selection items such as a selection item for switching a character type (kana input, alphabet input, numeral input etc.) used for the passkey entry. Note that, for simplification of description, this process is not shown in FIG. 12.

In S168, the operating-side pairing executing section 14 transmits the entered passkey to the apparatus selected in S166 via the operating-side second communication section 302. That is, the passkey is transmitted via Bluetooth communication. This is because a communication address of the apparatus to be paired with the remote operation apparatus 300 is acquired through the apparatus search, as described above.

After the transmission of the passkey, a pairing process is carried out without the need for the user to carry out any operation. Thus, the apparatus registration is carried out. Specifically, the operating-side pairing executing section 14 shifts to an apparatus information request awaiting mode (S169), and pairs the remote operation apparatus 300 with the apparatus (in this case, the operation target apparatus 200) to which the passkey has been transmitted.

In the pairing process, the operation target apparatus 200 transmits a service information request (S55), and the operating-side pairing executing section 14 confirms whether the service information request is received or not (S65). In a case where reception of the service information request cannot be confirmed (NO in S65), the operating-side pairing executing section 14 terminates the process without carrying out the pairing process. In this case, the process proceeds to S6 of FIG. 7 where it is determined that the pairing has failed. Then, the process returns to S2.

Meanwhile, in a case where reception of the service information request is confirmed (YES in S65), the operating-side pairing executing section 14 instructs the operating-side second communication section 302 to transmit service information to the operation target apparatus 200 (S66). Subsequently, the operating-side pairing executing section 14 causes a connection destination storage section 15 to store the apparatus information (address) of the operation target apparatus 200 which is received during the apparatus search, and then terminates the pairing process. Note that the service information and the service information request can be data shown in Table 5, for example.

After the completion of the pairing process, the process proceeds to S6 of FIG. 7. Note that the pairing process carried out in the remote operation apparatus 300 is not limited to this example, provided that the address of the operation target apparatus 200 can be acquired and registered and the address of the remote operation apparatus 300 can be transmitted to and registered in the operation target apparatus 200.

In S6 of FIG. 7, it is confirmed whether the pairing process has been successfully carried out or not. Here, the operating-side pairing executing section 14 may cause the display section 307 to display a screen as illustrated in (g) of FIG. 13. The “APPARATUS REGISTRATION (7/8)” displayed at the top of the screen of (g) of FIG. 13 allows the user to recognize that the screen is a screen for apparatus registration and that the seventh process out of eight processes is being carried out. Further, as illustrated in (g) of FIG. 13, a message notifying the user that the apparatus registration has been carried out is displayed on a central portion of the screen.

After the screen of (g) of FIG. 13 is displayed for a while, the operating-side pairing executing section 14 may cause the display section 307 to display a screen as illustrated in (h) of FIG. 13 so as to notify the user of completion of the apparatus registration and prompt the user to input a name to be used for management of the registered apparatus in the remote operation apparatus 300.

The “APPARATUS REGISTRATION (8/8)” displayed at the top of the screen of (h) of FIG. 13 allows the user to recognize that the screen is a screen for apparatus registration and that the eighth process out of eight processes is being carried out.

Further, as illustrated in (h) of FIG. 13, a message for prompting the user to change a name of the registered apparatus and a text box in which a name is entered are displayed on an upper portion of a central area of the screen. In the text box, a model name of the apparatus selected in S166 is displayed. Furthermore, as illustrated in (h) of FIG. 13, a message for notifying the user of completion of the apparatus registration and a selection item “END” are displayed on a lower portion of the central area of the screen, and a selection item “RETURN” is displayed on a bottom of the screen.

In a case where the screen as illustrated in (h) of FIG. 13 is displayed so that an input operation from the user can be accepted, the operating-side pairing executing section 14 causes, upon detection of an input operation with respect to the text box, the user to edit a text in the text box. Thus, the user can enter a desired text in the text box.

Then, upon detection of an input operation for selecting the selection item “END”, the operating-side executing section 14 causes the text in the text box to be stored as a name of the registered apparatus, and then finishes the apparatus registration (pairing). Thus, the user can use a desired name in managing the registered apparatus.

Meanwhile, in a case where entry of the passkey cannot be confirmed in S167, the operating-side pairing executing section 14 confirms whether or not a predetermined period of time has elapsed after the screen (e.g., (f) of FIG. 13) for accepting entry of a passkey is displayed (171).

In a case where the predetermined period of time has not elapsed (NO in S171), the process returns to S167 where the operating-side pairing executing section 14 awaits entry of a passkey. Meanwhile, in a case where the predetermined period of time has elapsed (YES in S171), the process returns to S165 where the operating-side pairing executing section 14 conducts an apparatus search again.

Note that it is also possible that in a case where the predetermined period of time has elapsed (YES in S171), it is determined that the pairing has failed, and the process shifts to S164 where the screen of (b) of FIG. 13 is displayed.

The above description has dealt with an example in which the operation target apparatus 200 transmits an apparatus information request to the remote operation apparatus 300, and the remote operation apparatus 300 which has received the apparatus information request transmits apparatus information (communication address) of the remote operation apparatus 300 to the operation target apparatus 200, as in the examples of FIGS. 7 and 9.

However, it is also possible that the remote operation apparatus 300 transmits an apparatus information request to the operation target apparatus 200 since the remote operation apparatus 300 can acquire a communication address of the operation target apparatus 200 through an apparatus search. In this case, it is possible to omit the process in S169 in which the operating-side pairing executing section 14 shifts to the apparatus information request awaiting mode.

[Process Flow (Operation Target Apparatus 200 Side)]

With reference to FIGS. 12 and 14, the following deals with an example of a process carried out by the operation target apparatus 200 in the present embodiment. Note that the process starts from S181 of FIG. 12 in a case where the operation target apparatus 200 is off, whereas in a case where the operation target apparatus 200 is on, the process starts from S182 of FIG. 12.

In response to receipt of a command from the remote operation apparatus 300 to turn on the operation target apparatus 200, the operation target apparatus 200 is turned ON (S181), and then receives a broadcast wave to broadcast (S182). Note that the process for turning on the operation target apparatus 200 is not limited particularly, as long as the operation target apparatus 200 is on during the processes in S183 and the subsequent steps.

After the operation target apparatus 200 is turned on, the operated-side pairing executing section 1 awaits a pairing start signal (S183). In a case where reception of the pairing start signal cannot be confirmed (NO in S183), the process returns to S182. That is, in this case, the operation target apparatus 200 continues broadcasting.

Meanwhile, in a case where reception of the pairing start signal is confirmed (YES in S183), the operated-side pairing executing section 1 generates a passkey and causes the display section 204 to display the passkey (S184). It is preferable that the passkey is the one which cannot be easily known by a third party and can be easily entered by a user. For example, four digit number that is randomly selected can be used as the passkey.

The passkey may be displayed on a screen as illustrated in (a) of FIG. 14, for example. On a top portion of the screen of (a) of FIG. 14, wording “APPARATUS REGISTRATION” is displayed. Further, on a central area of the screen, a passkey and a message for notifying the user that apparatus registration is to be carried out and that the user needs to carry out an operation by using a mobile phone (the remote operation apparatus 300) are displayed. Further, on a bottom portion of the screen, there is a message for notifying the user that the apparatus registration can be finished by selecting a selection item “MENU”.

This allows the user (i) to understand that the apparatus registration is to be carried out and that the apparatus registration is carried out by operating the mobile phone, and (ii) to know a passkey necessary for the apparatus registration. Moreover, the user can understand that the apparatus registration can be finished by selecting the selection item “MENU” provided on the operation target apparatus 200 or on a dedicated remote controller for the operation target apparatus 200.

Moreover, in a case where reception of the pairing start signal is confirmed (YES in S183), the operated-side pairing executing section 1 shifts to an apparatus information request awaiting mode (S185). Then, the operated-side pairing executing section 1 awaits apparatus information (address of the remote operation apparatus 300) and an apparatus information request which are transmitted when the remote operation apparatus 300 conducts an apparatus search (S186).

In a case where reception of the apparatus information and the apparatus information request cannot be confirmed within a predetermined period of time (e.g. 30 seconds) (NO in S186), the operated-side pairing executing section 1 ends the apparatus information request awaiting mode, and terminates the pairing process. Then, the process returns to S182.

In a case where a period of time in which a pairing process can be carried out is limited to a predetermined period of time as above, it is possible to prevent an electronic apparatus that is not intended by a user from being paired with the operation target apparatus 200.

Meanwhile, in a case where reception of the apparatus information and the apparatus information request is confirmed (YES in S186), the operated-side pairing executing section 1 instructs the operated-side second communication section 209 to transmit apparatus information (address) of the operation target apparatus 200 to the remote operation apparatus 300 (S187).

When the user of the remote operation apparatus 300 who saw the passkey displayed in S184 enters the passkey in the remote operation apparatus 300, the passkey is transmitted from the remote operation apparatus 300 to the operation target apparatus 200. In view of this, the operated-side pairing executing section 1 first confirms whether a predetermined period of time has elapsed after the passkey is displayed (S188).

In a case where it is confirmed that the predetermined period of time has elapsed (YES in S188), the process returns to S182 where the display section 204 displays a broadcasted image again. That is, in this case, the passkey generated and displayed in S184 is canceled, and a passkey is not generated until reception of a pairing start signal is newly confirmed.

The passkey is no longer displayed after a lapse of the predetermined period of time as above for the following reasons. One reason is that the fact that the passkey is not received after the passkey is displayed indicates that a user has no intention to carry out apparatus registration. Another reason is that if the passkey continues to be displayed, the passkey may be known by a third party. The predetermined period of time is not limited particularly, and can be appropriately set according to need. For example, the predetermined period of time is preferably about five minutes.

Meanwhile, in a case where the passkey is received within the predetermined period of time (NO in S188), the operated-side pairing executing section 1 confirms whether or not the passkey thus received matches the displayed passkey (S189).

In a case where the passkey thus received matches the displayed passkey, i.e., in a case where the passkey thus received is verified (YES in S189), the operated-side pairing executing section 1 carries out a pairing process.

Specifically, the operated-side pairing executing section 1 first instructs the operated-side second communication section 209 to transmit a service information request to the remote operation apparatus 300 (S55), and then awaits reception of service information (S56). Note that the service information and the service information request can be data shown in Table 5, for example.

In a case where reception of the service information cannot be confirmed within a predetermined period of time or in a case where received service information is not an appropriate one (NO in S56), the operated-side pairing executing section 1 terminates the process without carrying out pairing. As described above, appropriateness of the service information is determined depending on whether or not a service corresponding to the service information is available in the operation target apparatus 200.

In a case where the received service information is appropriate (YES in S56), the operated-side pairing executing section 1 causes the apparatus information of the remote operation apparatus 300 which is received in S186 and the service information received in S56 to be stored, and then terminates the pairing process (S57).

After the completion of the pairing process, the process in S23 of FIG. 7 is carried out. In a case where it is determined in S23 of FIG. 7 that the pairing has succeeded, the operated-side pairing executing section 1 may cause the display section 204 to display a screen as illustrated in (b) of FIG. 14 so as to notify the user of success of the apparatus registration (pairing).

On a top portion of the screen of (b) of FIG. 14, wording “APPARATUS REGISTRATION” is displayed. Further, on a central area of the screen, a message for notifying the user of completion of the apparatus registration and a model name of the registered apparatus are displayed. Further, on a bottom portion of the screen, a message for notifying the user that the apparatus registration can be finished by selecting the selection item “MENU” is displayed.

This allows the user to confirm that the apparatus registration has been completed and whether or not the remote operation apparatus 300 that is operated by the user has been registered. Moreover, the user can understand that the apparatus registration can be finished by selecting the selection item “MENU” provided on the operation target apparatus 200 or the dedicated remote controller for the operation target apparatus 200.

Note that the pairing process carried out in the operation target apparatus 200 is not limited to this example, as long as the address of the remote operation apparatus 300 can be acquired and registered, and the address of the operation target apparatus 200 can be transmitted to and then registered in the remote operation apparatus 300.

Meanwhile, in a case where the received passkey does not match the displayed passkey, i.e., in a case where passkey verification has failed (NO in S189), the process returns to S184 where the operated-side pairing executing section 1 displays a passkey again. In this case, it is preferable that the operated-side pairing executing section 1 newly generates a passkey.

In this way, in a case where passkey verification has failed, a passkey is newly generated so that a user needs to enter the newly generated passkey that is different from a previous one. This greatly reduces the risk that a third party who is not seeing the display section 204 of the operation target apparatus 200 acquires a passkey and operates the operation target apparatus 200.

In a case where the passkey verification has failed, the operated-side pairing executing section 1 may cause the display section 204 to display a screen as illustrated in (c) of FIG. 14 so as to notify the user of failure of the passkey verification and a new passkey.

On a top portion of the screen of (c) of FIG. 14, wording “APPARATUS REGISTRATION” is displayed. Further, on a central area of the screen, there are (i) a message for notifying the user that the apparatus registration has failed and that an operation for apparatus registration needs to be carried out again and (ii) a newly generated passkey. Further, on a bottom portion of the screen, there is a message for notifying the user that the apparatus registration can be finished by selecting the selection item “MENU”.

This allows the user to understand that the apparatus registration has failed and that the user needs to carry out an operation for apparatus registration again. Moreover, the user can acquire a passkey necessary for next apparatus registration. Moreover, the user can understand that the apparatus registration can be finished by selecting the selection item “MENU” provided on the operation target apparatus 200 or the dedicated remote controller for the operation target apparatus 200.

Note that the process carried out in a case where the passkey verification has failed is not limited to the above example. For example, it is also possible that in a case where the passkey verification has failed (NO in S186), the operated-side pairing executing section 1 cancels a displayed passkey (see (a) of FIG. 14), and the process returns to S183 where the operated-side pairing executing section 1 awaits a pairing start signal.

That is, it is possible that in a case where the passkey verification has failed (NO in S186), the operated-side pairing executing section 1 does not carry out the process of generating a passkey and causing the passkey to be displayed (S184) until a pairing start signal is newly received, as in the case where reception of a passkey cannot be confirmed within a predetermined period of time after the passkey is displayed (YES in S188).

That is, after the failure of the passkey verification, the operated-side pairing executing section 1 does not generate a passkey, i.e., does not carry out a pairing process until a pairing start signal is newly received. This reduces the risk that a passkey is figured out, thereby improving a security of the operation target apparatus 200.

The present invention is not limited to the description of the embodiments above, but may be altered by a skilled person within the scope of the claims. An embodiment based on a proper combination of technical means disclosed in different embodiments is encompassed in the technical scope of the present invention.

Finally, the blocks of the remote operation apparatus 300 and the operation target apparatus 200, especially the remote operation apparatus control section 306 and the operation target apparatus control section 203 may be realized by way of hardware or software as executed by a CPU as follows:

The remote operation apparatus 300 and the operation target apparatus 200 each include a CPU (central processing unit) and memory devices (memory media). The CPU (central processing unit) executes instructions in control programs realizing the functions. The memory devices include a ROM (read only memory) which contains programs, a RAM (random access memory) to which the programs are loaded, and a memory containing the programs and various data. The objective of the present invention can also be achieved by mounting to the remote operation apparatus 300 and the operation target apparatus 200 a computer-readable storage medium containing control program code (executable program, intermediate code program, or source program) for the remote operation apparatus 300 and the operation target apparatus 200, which is software realizing the aforementioned functions, in order for the computer (or CPU, MPU) to retrieve and execute the program code contained in the storage medium.

The storage medium may be, for example, a tape, such as a magnetic tape or a cassette tape; a magnetic disk, such as a Floppy (Registered Trademark) disk or a hard disk, or an optical disk, such as CD-ROM/MO/MD/DVD/CD-R; a card, such as an IC card (memory card) or an optical card; or a semiconductor memory, such as a mask ROM/EPROM/EEPROM/flash ROM.

The remote operation apparatus 300 and the operation target apparatus 200 may be arranged to be connectable to a communications network so that the program code may be delivered over the communications network. The communications network is not limited in any particular manner, and may be, for example, the Internet, an intranet, extranet, LAN, ISDN, VAN, CATV communications network, virtual dedicated network (virtual private network), telephone line network, mobile communications network, or satellite communications network. The transfer medium which makes up the communications network is not limited in any particular manner, and may be, for example, wired line, such as IEEE 1394, USB, electric power line, cable TV line, telephone line, or ADSL line; or wireless, such as infrared radiation (IrDA, remote control), Bluetooth (registered trademark), 802.11 wireless, HDR, mobile telephone network, satellite line, or terrestrial digital network. The present invention encompasses a computer data signal in which a carrier wave is embedded in which computer data signal the program code is embodied electronically.

As described above, a remote operation apparatus of the present invention includes: an operating-side first communication section that is capable of transmitting a signal to an operation target apparatus; an operating-side second communication section that is capable of transmitting/receiving a signal to/from the operation target apparatus; pairing start means which transmits a pairing start signal, which notifies a start of a pairing process, to the operation target apparatus via the operating-side first communication section; and operating-side pairing executing means which carries out the pairing process via the operating-side second communication section.

Further, as described above, an operation target apparatus of the present invention includes: an operated-side first communication section that is capable of receiving a signal transmitted by a remote operation apparatus; an operated-side second communication section that is capable of transmitting/receiving a signal to/from the remote operation apparatus; and operated-side pairing executing means which pairs the operation target apparatus with the remote operation apparatus via the operated-side second communication section in response to receipt, via the operated-side first communication section, of a pairing start signal for instructing a start of a pairing process.

This allows a user of the remote operation apparatus to carry out pairing between the remote operation apparatus and the operation target apparatus only by inputting an instruction to transmit a pairing start signal. That is, according to the arrangement, it is possible to very easily carry out a pairing process without causing a burden on the user.

Moreover, in order to carry out pairing, the operating-side first communication section is only required to transmit the pairing start signal, and the operated-side first communication section is only required to receive the pairing start signal. The paring process in which addresses are transmitted and received is carried out via the operating-side second communication section and the operated-side second communication section.

This allows infrared communication means which has been conventionally widely used for a remote controller etc. to be used as the operating-side first communication section and the operated-side first communication section, thereby reducing a manufacturing cost of the remote operation apparatus.

Further, it is preferable that the pairing executing means transmits a communication address of the remote operation apparatus to the operation target apparatus via the operating-side second communication section in response to receipt, via the operating-side second communication section, of (i) an operating-side apparatus information request signal for requesting the remote operation apparatus to transmit the communication address of the remote operation apparatus to the operation target apparatus and (ii) a communication address of the operation target apparatus.

According to the arrangement, the remote operation apparatus receives the communication address of the operation target apparatus along with the operating-side apparatus information request signal, and then transmits the communication address of the remote operation apparatus to the operation target apparatus.

According to the arrangement, the remote operation apparatus thus transmits the communication address of the remote operation apparatus to the communication address of the operation target apparatus which the remote operation apparatus has received. This makes it possible to prevent the communication address of the remote operation apparatus from being received by another electronic apparatus, thereby making it possible to surely carry out pairing between the remote operation apparatus and the operation target apparatus.

Further, it is preferable that the operating-side pairing executing means transmits the communication address of the remote operation apparatus at least in a case where the operating-side apparatus information request signal and the communication address of the operation target apparatus are received within a predetermined period of time after the transmission of the pairing start signal, and does not transmit the communication address of the remote operation apparatus after a lapse of the predetermined period of time.

According to the arrangement, the communication address of the remote operation apparatus is transmitted in a case where the operating-side apparatus information request signal and the communication address of the operation target apparatus are received within a predetermined period of time after the transmission of the pairing start signal. Meanwhile, in a case where the operating-side apparatus information request signal etc. is received after a lapse of the predetermined period of time, pairing is not carried out.

The pairing start signal is a signal transmitted when pairing is carried out between the remote operation apparatus and the operation target apparatus. Specifically, according to the arrangement, pairing can be carried out only for a predetermined period of time after transmission of the pairing start signal.

As such, even if the operating-side apparatus information request signal etc. is received from the operation target apparatus in a case where pairing is not carried out, pairing with the operation target apparatus is not carried out. That is, according to the above arrangement, it is possible to prevent the remote operation apparatus from being paired with an electronic apparatus that is not intended by a user.

Note that the predetermined period of time is a time sufficient for the remote operation apparatus to confirm reception of the operating-side apparatus information request signal transmitted from the operation target apparatus which has received the pairing start signal. Further, it is preferable that the predetermined period of time is as short as possible in order to prevent the remote operation apparatus from being paired with an electronic apparatus that is not intended by a user. In view of this, the predetermined period of time is 30 seconds or shorter, for example.

Further, the operating-side pairing executing means may transmit, to the operation target apparatus, (i) an operated-side apparatus information request signal for requesting transmission of a communication address of the operation target apparatus and (ii) a communication address of the remote operation apparatus.

According to the arrangement, the operating-side pairing executing means transmits, to the operation target apparatus, an operated-side apparatus information request signal and a communication address of the remote operation apparatus. In response to this, the operation target apparatus transmits the communication address of the operation target apparatus to the communication address of the remote operation apparatus which the operation target apparatus has received. Thus, the remote operation apparatus can recognize the communication address of the operation target apparatus. Note that the operated-side apparatus information request signal and the communication address of the remote operation apparatus are transmitted concurrently with transmission of the pairing start signal or at any timing after transmission of the pairing start signal.

Further, it is preferable that the pairing start means transmits the pairing start signal via the operating-side first communication section in response to an input operation for remotely operating the operation target apparatus, and the remote operation apparatus further includes: the operating-side communication control means which, after the pairing process is executed by the operating-side pairing executing means, transmits a signal for remotely operating the operation target apparatus which signal corresponds to the input operation to the operation target apparatus via the operating-side second communication section.

Although the transmission of the pairing start signal by the pairing start means may be triggered by any operation, it is preferable that the transmission of the pairing start signal is triggered by the input operation for remotely operating the operation target apparatus, as in the above arrangement.

In this case, pairing is automatically carried out just by a user's input operation for remotely operating the operation target apparatus, and a signal for remotely operating the operation target apparatus is transmitted via the operating-side second communication section. It is therefore possible to operate the operation target apparatus with the use of a signal transmitted/received via the operating-side second communication section without the need for the user to carry out any special operation.

Further, it is preferable that in response to receipt of the pairing start signal, the operated-side pairing executing means of the operation target apparatus transmits, to the remote operation apparatus via the operated-side second communication section, (i) an operating-side apparatus information request signal for requesting the remote operation apparatus to transmit a communication address of the remote operation apparatus and (ii) a communication address of the operation target apparatus.

According to the arrangement, in a case where there are a plurality of operation target apparatuses which can communicate with the remote operation apparatus, the remote operation apparatus which has received a pairing start signal from any one of the plurality of operation target apparatuses can judge, based on the communication address received along with the operating-side apparatus information request signal, with which of the plurality of operation target apparatuses pairing should be carried out. As such, according to the arrangement, the present invention can be applied even in a case where a plurality of operation target apparatuses are operated by a single remote operation apparatus.

Further, the operated-side pairing executing means may transmit a communication address of the operation target apparatus to the remote operation apparatus via the operated-side second communication section in response to receipt, via the operated-side second communication section, of (i) an operated-side apparatus information request signal for requesting the operation target apparatus to transmit the communication address of the operation target apparatus to the remote operation apparatus and (ii) a communication address of the remote operation apparatus.

According to the arrangement, the operated-side pairing executing means receives the operated-side apparatus information request signal, and then transmits the communication address of the operation target apparatus to the remote operation apparatus. Thus, the remote operation apparatus can recognize the communication address of the operation target apparatus.

Further, it is preferable that the operated-side pairing executing means transmits the communication address of the operation target apparatus in a case where the operated-side apparatus information request signal and the communication address of the remote operation apparatus are received within a predetermined period of time after the receipt of the pairing start signal, and does not transmit the communication address of the operation target apparatus after a lapse of the predetermined period of time.

According to the arrangement, the communication address of the operation target apparatus is transmitted in a case where the operated-side apparatus information request signal and the communication address of the remote operation apparatus are received within a predetermined period of time after the reception of the pairing start signal. Meanwhile, in a case where the operated-side apparatus information request signal etc. is received after a lapse of the predetermined period of time, the communication address of the operation target apparatus is not transmitted.

The pairing start signal is a signal transmitted when pairing is carried out between the remote operation apparatus and the operation target apparatus. Specifically, according to the arrangement, pairing can be carried out only for a predetermined period of time after reception of the pairing start signal.

As such, according to the arrangement, even if the operated-side apparatus information request signal etc. is received from the remote operation apparatus in a case where pairing is not carried out, pairing with the remote operation apparatus is not carried out. That is, according to the above arrangement, it is possible to prevent the operation target apparatus from being paired with an electronic apparatus that is not intended by a user.

Further, it is preferable that the operation target apparatus further includes: password output means which outputs an output password after the receipt of the pairing start signal; and password collating means which judges whether or not a received password received from the remote operation apparatus matches the output password outputted by the password output means, the operated-side pairing executing means pairing the operation target apparatus with the remote operation apparatus via the operated-side second communication section in a case where the password collating means determines that the received password matches the output password.

According to the arrangement, pairing is carried out only in a case where the output password outputted by the password output means after the receipt of the pairing start signal matches the received password received from the remote operation apparatus. That is, according to the arrangement, only a remote operation apparatus which has acquired the output password outputted by the operation target apparatus can be paired with the operation target apparatus.

Therefore, according to the arrangement, it is possible to prevent the operation target apparatus from being paired with and being remotely operated by a third party's apparatus that is not intended by a user. That is, it is possible to improve a security of the operation target apparatus.

Although how the password output means outputs a password is not limited in particular, it is preferable that the password output means outputs a password in a manner such that the password cannot be easily acquired by a third party. For example, in a case where the operation target apparatus includes a display section, the password may be outputted and displayed on the display section. This allows only a user who can see the display section of the operation target apparatus to carry out pairing with the operation target apparatus. Alternatively, for example, in a case where the operated-side first communication section carries out directional communication such as infrared communication and has a signal transmitting function, the password may be transmitted from the operated-side first communication section.

Note that it is preferable that the output password is not fixed, but is generated when a pairing start signal is received. This further improves security of the operation target apparatus.

Further, it is preferable that the password output means changes the output password in a case where the password collating means determines that the received password does not match the output password.

According to the arrangement, the output password is changed in a case where it is determined that the received password does not match the output password. This can prevent a third party from figuring out the output password, thereby improving security of the operation target apparatus. Note that the predetermined period of time is not limited in particular, and therefore can be appropriately set according to need in consideration of a time necessary for the received password to be received from the remote operation apparatus. However, it is preferable that the predetermined period of time is about five minutes, for example.

Further, it is preferable that the operated-side pairing executing means cancels the output password outputted by the password output means (i) in a case where reception of the received password is not confirmed within a predetermined period of time after output of the output password and/or (ii) in a case where the password collating means determines that the received password does not match the output password.

According to the arrangement, the output password is canceled (i) in a case where reception of the received password is not confirmed within a predetermined period of time after output of the output password and/or (ii) in a case where it is determined that the received password does not match the output password.

In a case where the output password is canceled, pairing cannot be carried out. As such, the arrangement makes it possible to prevent a third party from figuring out the output password, thereby improving security of the operation target apparatus. Note that the predetermined period of time is not limited in particular, and therefore can be appropriately set according to need in consideration of a time necessary for the received password to be received from the remote operation apparatus. However, it is preferable that the predetermined period of time is about five minutes, for example.

In a remote operation system including the remote operation apparatus and the operation target apparatus, pairing can be very easily carried out without causing a burden on a user, and infrared communication means which has been widely used for a remote controller etc. can be used as the operating-side first communication section and the operated-side first communication section.

As described above, a remote operation apparatus of the present invention includes: an operating-side first communication section that is capable of transmitting a signal to an operation target apparatus; an operating-side second communication section that is capable of transmitting/receiving a signal to/from the operation target apparatus; communication start control means which transmits a connection start signal, which notifies a start of the transmission/reception of the signal via the operating-side second communication section, to the operation target apparatus via the operating-side first communication section; and operating-side communication control means which transmits/receives the signal to/from the operation target apparatus via the operating-side second communication section.

As described above, an operation target apparatus of the present invention includes: an operated-side first communication section that is capable of receiving a signal transmitted by a remote operation apparatus; an operated-side second communication section that is capable of transmitting/receiving a signal to/from the remote operation apparatus; and the operated-side communication control means which transmits/receives the signal to/from the remote operation apparatus via the operated-side second communication section in response to receipt, via the operated-side first communication section, of a connection start signal for notifying a start of the transmission/reception of the signal via the operated-side second communication section.

With the arrangement, the remote operation apparatus can easily specify an operation target apparatus to/from which a signal is to be transmitted/received via the operating-side second communication section, and the operation target apparatus can easily specify a remote operation apparatus to/from which a signal is to be transmitted/received via the operated-side second communication section.

Moreover, the operating-side first communication section is only required to transmit a connection start signal in order to specify an apparatus to be transmitted/received via the operating-side second communication section, and the operated-side first communication section is only required to receive a connection start signal in order to specify an apparatus to be transmitted/received via the operated-side second communication section. This allows an amount of data transmitted from the operating-side first communication section to the operated-side first communication section to be suppressed to a bare minimum. As such, according to the arrangement, infrared communication means which has been widely used for a remote controller etc. can be used as the operating-side first communication section and the operated-side first communication section. This allows a reduction in manufacturing cost of the remote operation apparatus.

Further, it is preferable that in response to a connection request signal received from the operation target apparatus via the operating-side second communication section which connection request signal is a signal for requesting communication connection with the operation target apparatus, the operating-side communication control means establishing communication connection with the operation target apparatus via the operating-side second communication section through designation of a communication address of the remote operation apparatus by the operation target apparatus and designation of a communication address of the operation target apparatus by the remote operation apparatus.

According to the arrangement, in a case where a signal is transmitted and received via the operating-side second communication section, the remote operation apparatus and the operation target apparatus designate each other's communication addresses so that communication connection is established between the remote operation apparatus and the operation target apparatus. This makes it possible to prevent a signal transmitted/received via the operating-side second communication section from being received by another electronic apparatus. As such, according to the arrangement, it is possible to prevent an electronic apparatus that is not intended by a user of the remote operation apparatus from being mistakenly operated by a signal transmitted from the remote operation apparatus.

Further, it is preferable that the operating-side communication control means establishes the communication connection via the operating-side second communication section at least in a case where the connection request signal is received within a predetermined period of time after transmission of the connection start signal by the communication start control means, and does not establish the communication connection after a lapse of the predetermined period of time.

According to the arrangement, communication connection is established via the operating-side second communication section in a case where the connection request signal is received within a predetermined period of time after transmission of the connection start signal. Meanwhile, communication connection is not established via the operating-side second communication section in a case where the connection request signal is received after a lapse of the predetermined period of time.

The connection start signal is a signal transmitted when communication connection between the remote operation apparatus and the operation target apparatus is established via the operating-side second communication section. Specifically, according to the arrangement, establishment of communication connection is allowed only for a predetermined period of time after transmission of the connection start signal.

Accordingly, even if a connection request signal is received from an operation target apparatus while the remote operation apparatus is not being used, communication connection is not established. That is, according to the arrangement, it is possible to prevent communication connection from being established between the remote operation apparatus and an apparatus that is not intended by a user.

Note that the predetermined period of time is a time sufficient for the remote operation apparatus to confirm reception of the connection request signal transmitted from the operation target apparatus which has received the connection start signal. Further, it is preferable that the predetermined period of time is as short as possible in order to prevent communication connection from being established between the remote operation apparatus and an electronic apparatus that is not intended by a user. In view of this, the predetermined period of time is 30 seconds or shorter, for example.

Further, it is preferable that the connection request signal contains operation target apparatus identification information for identifying the operation target apparatus which has transmitted the connection request signal, the remote operation apparatus further includes: an operating-side connection destination storage section in which (i) the operation target apparatus with which the remote operation apparatus is to be communicated via the operating-side second communication section and (ii) the communication address of the operation target apparatus are associated with each other; and operating-side connection destination collating means which judges whether or not the operation target apparatus corresponding to the operation target apparatus identification information contained in the connection request signal is registered in the operating-side connection destination storage section, and the operating-side communication control means establishes the communication connection with the operation target apparatus via the operating-side second communication section in a case where the operating-side connection destination collating means determines that the operation target apparatus corresponding to the operation target apparatus identification information is registered in the operating-side connection destination storage section.

As described above, the operation target apparatus transmits a connection request signal in response to receipt of a connection start signal transmitted from the operating-side first communication section of the remote operation apparatus. Here, if the connection start signal is received by an electronic apparatus that is not intended by a user, there is a risk that a connection request signal is transmitted from the electronic apparatus so that communication connection is established between the remote operation apparatus and the electronic apparatus that is not intended by the user.

In view of this, according to the arrangement, an operation target apparatus which has transmitted a connection request signal is confirmed by using identification information of the operation target apparatus which is contained in the connection request signal. This makes it possible to prevent communication connection from being established between the remote operation apparatus and an electronic apparatus that is not intended by a user.

Further, it is preferable that the communication start control means transmits remote operation apparatus identification information along with the connection start signal to the operation target apparatus via the operating-side first communication section, the remote operation apparatus identification information being information for causing the operation target apparatus to identify the remote operation apparatus.

According to the arrangement, in a case where there are a plurality of remote operation apparatuses which can communicate with the operation target apparatus, the operation target apparatus which has received a connection start signal from any one of the plurality of remote operation apparatuses can judge with which of the plurality of remote operation apparatuses communication should be established. As such, according to the arrangement, the present invention can be applied even in a case where a single operation target apparatus is operated by a plurality of remote operation apparatuses.

Further, it is preferable that the communication start control means transmits the connection start signal via the operating-side first communication section in response to an input operation for remotely operating the operation target apparatus, and the operating-side communication control means transmits a signal for remotely operating the operation target apparatus which signal corresponds to the input operation to the operation target apparatus via the operating-side second communication section.

Although the transmission of the connection start signal by the communication start control means may be triggered by any operation, it is preferable that the transmission of the connection start signal is triggered by the input operation for remotely operating the operation target apparatus, as in the above arrangement.

In this case, communication is automatically established via the operating-side second communication section just by a user's input operation for remotely operating the operation target apparatus, and a signal for remotely operating the operation target apparatus is transmitted via the operating-side second communication section. It is therefore possible to operate the operation target apparatus with the use of a signal transmitted/received via the operating-side second communication section without the need for the user to carry out any special operation.

Further, it is preferable that in response to receipt of the connection start signal, the operated-side communication control means transmits a connection request signal to the remote operation apparatus via the operated-side second communication section, the connection request signal being a signal for requesting the remote operation apparatus to establish a communication connection with the operation target apparatus via the operated-side second communication section through designation of a communication address of the remote operation apparatus by the operation target apparatus and designation of a communication address of the operation target apparatus by the remote operation apparatus.

According to the arrangement, in a case where a signal is transmitted and received via the operated-side second communication section, the remote operation apparatus and the operation target apparatus designate each other's communication addresses so that communication connection is established between the remote operation apparatus and the operation target apparatus. This makes it possible to prevent a signal transmitted/received via the operated-side second communication section from being received by another electronic apparatus.

Further, it is preferable that the operated-side communication control means transmits operation target apparatus identification information along with the connection request signal to the remote operation apparatus, the operation target apparatus identification information for causing the remote operation apparatus to identify the operation target apparatus.

According to the arrangement, in a case where there are a plurality of operation target apparatuses which can communicate with the remote operation apparatus, the remote operation apparatus which has received a connection request signal from any one of the plurality of operation target apparatuses can judge with which of the plurality of operation target apparatuses communication should be established. As such, according to the arrangement, the present invention can be applied even in a case where a plurality of operation target apparatuses are operated by a single remote operation apparatus.

Further, it is preferable that the connection start signal contains remote operation apparatus identification information for identifying the remote operation apparatus which has transmitted the connection start signal, the operation target apparatus further includes: an operated-side connection destination storage section in which the remote operation apparatus with which the operation target apparatus is to be communicated and a communication address of the remote operation apparatus are associated with each other; and operated-side connection destination collating means which judges whether or not the remote operation apparatus corresponding to the remote operation apparatus identification information contained in the connection start signal is registered in the operated-side connection destination storage section, and the operated-side communication control means establishes communication connection with the remote operation apparatus via the operated-side second communication section in a case where the operated-side connection destination collating means determines that the remote operation apparatus corresponding to the remote operation apparatus identification information is registered in the operated-side connection destination storage section.

As described above, the operation target apparatus transmits a connection request signal in response to receipt of a connection start signal. Thus, communication connection is established via the operated-side second communication section. Here, the operation target apparatus cannot judge with which remote operation apparatus communication connection should be established via the operated-side second communication section, when a connection request signal is received in a case where communication connection can be established between the operation target apparatus and a plurality of remote operation apparatuses via the operated-side second communication section, i.e., in a case where communication addresses of the respective remote operation apparatuses are stored in the operation target apparatus and where the remote operation apparatuses stores the respective communication addresses.

In view of this, according to the arrangement, a remote operation apparatus which has transmitted a connection start signal is confirmed with the use of identification information of the remote operation apparatus which is contained in the connection start signal. This makes it possible to specify the remote operation apparatus which has transmitted the connection start signal. Thus, communication connection between the operation target apparatus and the remote operation apparatus thus specified can be established via the operated-side second communication section.

Further, in a remote operation system including the remote operation apparatus and the operation target apparatus, it is possible to very easily specify an apparatus to/from which a signal is transmitted/received via the operating-side second communication section and an apparatus to/from which a signal is transmitted/received via the operated-side second communication section, and it is possible to suppress an amount of data transmitted from the operating-side first communication section to the operated-side first communication section to a bare minimum.

The embodiments and concrete examples of implementation discussed in the foregoing detailed explanation serve solely to illustrate the technical details of the present invention, which should not be narrowly interpreted within the limits of such embodiments and concrete examples, but rather may be applied in many variations within the spirit of the present invention, provided such variations do not exceed the scope of the patent claims set forth below.

### INDUSTRIAL APPLICABILITY

According to the present invention, a reconnection process and a pairing process can be easily carried out. As such, the present invention can be applied to various apparatuses which carry out a pairing process so as to establish communication. The present invention can be applied especially to an electronic apparatus such as a television, a picture recorder or a personal computer, and a remote operation apparatus which operates the electronic apparatus.

1. A remote operation apparatus which remotely operates an operation target apparatus by transmitting a signal to the operation target apparatus, comprising:
an operating-side first communication section that is capable of transmitting a signal to the operation target apparatus;
an operating-side second communication section that is capable of transmitting/receiving a signal to/from the operation target apparatus; and
at least one of a first arrangement and a second arrangement,
the first arrangement including: operating-side pairing start means which transmits a pairing start signal, which instructs a start of a pairing process, to the operation target apparatus via the operating-side first communication section; and operating-side pairing executing means which executes the pairing process via the operating-side second communication section,
the second arrangement including: communication start control means which transmits a connection start signal, which notifies a start of the transmission/reception of the signal via the operating-side second communication section, to the operation target apparatus via the operating-side first communication section; and operating-side communication control means which transmits/receives the signal to/from the operation target apparatus via the operating-side second communication section.

2. The remote operation apparatus according to claim 1, comprising at least the first arrangement, wherein:
the operating-side pairing executing means transmits a communication address of the remote operation apparatus to the operation target apparatus via the operating-side second communication section in response to receipt, via the operating-side second communication section, of (i) an operating-side apparatus information request signal for requesting the remote operation apparatus to transmit the communication address of the remote operation apparatus to the operation target apparatus and (ii) a communication address of the operation target apparatus.

3. The remote operation apparatus according to claim 2, wherein:
the operating-side pairing executing means transmits the communication address of the remote operation apparatus at least in a case where the operating-side apparatus information request signal and the communication address of the operation target apparatus are received within a predetermined period of time after the transmission of the pairing start signal, and does not transmit the communication address of the remote operation apparatus after a lapse of the predetermined period of time.

4. The remote operation apparatus according to claim 1, comprising at least the first arrangement, wherein:
the operating-side pairing executing means transmits, to the operation target apparatus, (i) an operated-side apparatus information request signal for requesting transmission of a communication address of the operation target apparatus and (ii) a communication address of the remote operation apparatus.

5. The remote operation apparatus according to claim 1, comprising at least the first arrangement, wherein:
the pairing start means transmits the pairing start signal via the operating-side first communication section in response to an input operation for remotely operating the operation target apparatus,
the remote operation apparatus further comprising:
the operating-side communication control means which, after the pairing process is executed by the operating-side pairing executing means, transmits a signal for remotely operating the operation target apparatus which signal corresponds to the input operation to the operation target apparatus via the operating-side second communication section.

6. The remote operation apparatus according to claim 1, comprising at least the second arrangement, wherein:
in response to a connection request signal received from the operation target apparatus via the operating-side second communication section which connection request signal is a signal for requesting communication connection with the operation target apparatus, the operating-side communication control means establishes communication connection with the operation target apparatus via the operating-side second communication section through designation of a communication address of the remote operation apparatus by the operation target apparatus and designation of a communication address of the operation target apparatus by the remote operation apparatus.

7. The remote operation apparatus according to claim 6, wherein:
the operating-side communication control means establishes the communication connection via the operating-side second communication section at least in a case where the connection request signal is received within a predetermined period of time after transmission of the connection start signal by the communication start control means, and does not establish the communication connection after a lapse of the predetermined period of time.

8. The remote operation apparatus according to claim 6, wherein:
the connection request signal contains operation target apparatus identification information for identifying the operation target apparatus which has transmitted the connection request signal,
the remote operation apparatus further comprising:
an operating-side connection destination storage section in which (i) the operation target apparatus with which the remote operation apparatus is to be communicated via the operating-side second communication section and (ii) the communication address of the operation target apparatus are associated with each other; and
operating-side connection destination collating means which judges whether or not the operation target apparatus corresponding to the operation target apparatus identification information contained in the connection request signal is registered in the operating-side connection destination storage section,
the operating-side communication control means establishing the communication connection with the operation target apparatus via the operating-side second communication section in a case where the operating-side connection destination collating means determines that the operation target apparatus corresponding to the operation target apparatus identification information is registered in the operating-side connection destination storage section.

9. The remote operation apparatus according to claim 1, comprising at least the second arrangement, wherein:
the communication start control means transmits remote operation apparatus identification information along with the connection start signal to the operation target apparatus via the operating-side first communication section, the remote operation apparatus identification information being information for causing the operation target apparatus to identify the remote operation apparatus.

10. The remote operation apparatus according to claim 1, comprising at least the second arrangement, wherein:
the communication start control means transmits the connection start signal via the operating-side first communication section in response to an input operation for remotely operating the operation target apparatus, and
the operating-side communication control means transmits a signal for remotely operating the operation target apparatus which signal corresponds to the input operation to the operation target apparatus via the operating-side second communication section.

11. An operation target apparatus whose operation is controlled based on a signal transmitted from a remote operation apparatus, comprising:
an operated-side first communication section that is capable of receiving a signal transmitted by the remote operation apparatus;
an operated-side second communication section that is capable of transmitting/receiving a signal to/from the remote operation apparatus; and
at least one of operated-side pairing executing means and operated-side communication control means,
the operated-side pairing executing means pairing the operation target apparatus with the remote operation apparatus via the operated-side second communication section in response to receipt, via the operated-side first communication section, of a pairing start signal for instructing a start of a pairing process,
the operated-side communication control means transmitting/receiving the signal to/from the remote operation apparatus via the operated-side second communication section in response to receipt, via the operated-side first communication section, of a connection start signal for notifying a start of the transmission/reception of the signal via the operated-side second communication section.

12. The operation target apparatus according to claim 11, comprising at least the operated-side pairing executing means, wherein:
in response to receipt of the pairing start signal, the operated-side pairing executing means transmits, to the remote operation apparatus via the operated-side second communication section, (i) an operating-side apparatus information request signal for requesting the remote operation apparatus to transmit a communication address of the remote operation apparatus and (ii) a communication address of the operation target apparatus.

13. The operation target apparatus according to claim 11, comprising at least the operated-side pairing executing means, wherein:
the operated-side pairing executing means transmits a communication address of the operation target apparatus to the remote operation apparatus via the operated-side second communication section in response to receipt, via the operated-side second communication section, of (i) an operated-side apparatus information request signal for requesting the operation target apparatus to transmit the communication address of the operation target apparatus to the remote operation apparatus and (ii) a communication address of the remote operation apparatus.

14. The operation target apparatus according to claim 13, wherein:
the operated-side pairing executing means transmits the communication address of the operation target apparatus in a case where the operated-side apparatus information request signal and the communication address of the remote operation apparatus are received within a predetermined period of time after the receipt of the pairing start signal, and does not transmit the communication address of the operation target apparatus after a lapse of the predetermined period of time.

15. The operation target apparatus according to claim 11, comprising at least the operated-side pairing executing means,
the operation target apparatus further comprising:
password output means which outputs an output password after the receipt of the pairing start signal; and
password collating means which judges whether or not a received password received from the remote operation apparatus matches the output password outputted by the password output means,
the operated-side pairing executing means pairing the operation target apparatus with the remote operation apparatus via the operated-side second communication section in a case where the password collating means determines that the received password matches the output password.

16. The operation target apparatus according to claim 15, wherein:
the password output means changes the output password in a case where the password collating means determines that the received password does not match the output password.

17. The operation target apparatus according to claim 15, wherein:
the operated-side pairing executing means cancels the output password outputted by the password output means (i) in a case where reception of the received password is not confirmed within a predetermined period of time after output of the output password and/or (ii) in a case where the password collating means determines that the received password does not match the output password.

18. The operation target apparatus according to claim 11, comprising at least the operated-side communication control means, wherein:
in response to receipt of the connection start signal, the operated-side communication control means transmits a connection request signal to the remote operation apparatus via the operated-side second communication section, the connection request signal being a signal for requesting the remote operation apparatus to establish a communication connection with the operation target apparatus via the operated-side second communication section through designation of a communication address of the remote operation apparatus by the operation target apparatus and designation of a communication address of the operation target apparatus by the remote operation apparatus.

19. The operation target apparatus according to claim 18, wherein:
the operated-side communication control means transmits operation target apparatus identification information along with the connection request signal to the remote operation apparatus, the operation target apparatus identification information for causing the remote operation apparatus to identify the operation target apparatus.

20. The operation target apparatus according to claim 11, comprising at least the operated-side communication control means, wherein:
the connection start signal contains remote operation apparatus identification information for identifying the remote operation apparatus which has transmitted the connection start signal,
the operation target apparatus further comprising:
an operated-side connection destination storage section in which the remote operation apparatus with which the operation target apparatus is to be communicated and a communication address of the remote operation apparatus are associated with each other; and
operated-side connection destination collating means which judges whether or not the remote operation apparatus corresponding to the remote operation apparatus identification information contained in the connection start signal is registered in the operated-side connection destination storage section,
the operated-side communication control means establishing communication connection with the remote operation apparatus via the operated-side second communication section in a case where the operated-side connection destination collating means determines that the remote operation apparatus corresponding to the remote operation apparatus identification information is registered in the operated-side connection destination storage section.

21. A method for controlling a remote operation apparatus which remotely operates an operation target apparatus by transmitting a signal to the operation target apparatus, the remote operation apparatus including an operating-side first communication section that is capable of transmitting a signal to the operation target apparatus; and an operating-side second communication section that is capable of transmitting/receiving a signal to/from the operation target apparatus,
the method comprising at least one of a first step and a second step:
the first step including: transmitting a pairing start signal, which instructs a start of a pairing process, to the operation target apparatus via the operating-side first communication section; and executing the pairing process via the operating-side second communication section,
the second step including: transmitting a connection start signal, which notifies a start of the transmission/reception of the signal via the operating-side second communication section, to the operation target apparatus via the operating-side first communication section; and transmitting/receiving the signal to/from the operation target apparatus via the operating-side second communication section.

22. A method for controlling an operation target apparatus whose operation is controlled based on a signal transmitted from a remote operation apparatus, the operation target apparatus including: an operated-side first communication section that is capable of receiving a signal transmitted by the remote operation apparatus; and an operated-side second communication section that is capable of transmitting/receiving a signal to/from the remote operation apparatus,
the method comprising at least one of a first step and a second step,
the first step including: receiving a pairing start signal for instructing a start of a pairing process via the operated-side first communication section; and pairing the operation target apparatus with the remote operation apparatus via the operated-side second communication section in response to receipt of the pairing start signal,
the second step including: receiving, via the operated-side first communication section, a connection start signal for notifying a start of the transmission/reception of the signal via the operated-side second communication section; and transmitting/receiving the signal to/from the remote operation apparatus via the operated-side second communication section in response to receipt of the connection start signal.

23. A remote operation system comprising: a remote operation apparatus and an operation target apparatus,
the remote operation apparatus remotely operating the operation target apparatus by transmitting a signal to the operation target apparatus, the remote operation apparatus including: an operating-side first communication section that is capable of transmitting a signal to the operation target apparatus; an operating-side second communication section that is capable of transmitting/receiving a signal to/from the operation target apparatus; and at least one of a first arrangement and a second arrangement, the first arrangement including: operating-side pairing start means which transmits a pairing start signal, which instructs a start of a pairing process, to the operation target apparatus via the operating-side first communication section; and operating-side pairing executing means which executes the pairing process via the operating-side second communication section, the second arrangement including: communication start control means which transmits a connection start signal, which notifies a start of the transmission/reception of the signal via the operating-side second communication section, to the operation target apparatus via the operating-side first communication section; and operating-side communication control means which transmits/receives the signal to/from the operation target apparatus via the operating-side second communication section,
the operation target apparatus whose operation is controlled based on the signal transmitted from the remote operation apparatus, including: an operated-side first communication section that is capable of receiving the signal transmitted by the remote operation apparatus; an operated-side second communication section that is capable of transmitting/receiving the signal to/from the remote operation apparatus; and at least one of operated-side pairing executing means and operated-side communication control means, the operated-side pairing executing means pairing the operation target apparatus with the remote operation apparatus via the operated-side second communication section in response to receipt, via the operated-side first communication section, of the pairing start signal for instructing the start of the pairing process, the operated-side communication control means transmitting/receiving the signal to/from the remote operation apparatus via the operated-side second communication section in response to receipt, via the operated-side first communication section, of the connection start signal for notifying the start of the transmission/reception of the signal via the operated-side second communication section.
